(19) United States
(12) Patent Application Publication
(10) Pub. No.: US 2025/0281826 A1
(43) Pub. Date: Sep. 11, 2025

(54) METHOD AND APPARATUS FOR SHIFTING GEAR OF VIRTUAL VEHICLE, DEVICE, AND STORAGE MEDIUM

(71) Applicant: Tencent Technology (Shenzhen) Company Limited, Shenzhen (CN)

(72) Inventors: Dancheng ZOU, Shenzhen (CN); Shayuan XU, Shenzhen (CN)

(21) Appl. No.: 19/219,890

(22) Filed: May 27, 2025

Related U.S. Application Data
(63) Continuation of application No. PCT/CN2024/080561, filed on Mar. 7, 2024.

(30) Foreign Application Priority Data
Apr. 28, 2023 (CN) 202310489031.7

(51) Int. Cl. A63F 13/2145; A63F 13/537; A63F 13/803; G06F 3/0346; G06F 3/0488

(52) U.S. Cl. CPC A63F 13/2145; A63F 13/537; A63F 13/803; G06F 3/0346; G06F 3/0488

(57) ABSTRACT

This application discloses a method for shifting a gear of a virtual vehicle in a virtual environment performed by a computer device. The method includes: displaying, in a user interface, the virtual vehicle in a travel state in the virtual environment; acquiring terminal motion data from a motion sensor in the computer device; determining a tapping operation on a surface of a display of the computer device according to the terminal motion data; and in response to a gear shifting instruction triggered by the tapping operation, performing at least one of upshifting the gear of the virtual vehicle and downshifting the gear of the virtual vehicle according to the gear shifting instruction. The tapping operation is different from a touch operation on a display screen of the computer device, and is independent from the touch operation of a user on the display screen, thus achieving high operation accuracy.

### CROSS-REFERENCE TO RELATED APPLICATIONS

This application is a continuation application of PCT Patent Application No. PCT/CN2024/080561, entitled “METHOD AND APPARATUS FOR SHIFTING GEAR OF VIRTUAL VEHICLE, DEVICE, AND STORAGE MEDIUM” filed on Mar. 7, 2024, which claims priority to Chinese Patent Application 202310489031.7, entitled “METHOD AND APPARATUS FOR SHIFTING GEAR OF VIRTUAL VEHICLE, DEVICE, AND STORAGE MEDIUM” and filed on Apr. 28, 2023, both of which are incorporated herein by reference in their entirety.

### FIELD OF THE TECHNOLOGY

This application relates to the field of application programs that support virtual environments, and in particular, to a method and apparatus for shifting a gear of a virtual vehicle, a device, and a storage medium.

### BACKGROUND OF THE DISCLOSURE

In automobile racing games, users can control virtual automobiles to travel in a virtual environment. The user's control over the virtual automobile includes controlling the travel direction (such as forwarding, reversing, turning left, and turning right) and travel speed of the virtual automobile, and the use of virtual props (such as nitrogen acceleration props). For automobiles in the real world, there is a need of gear shifting during travel. The gear is inversely proportional to the automobile's acceleration ability and directly proportional to the automobile's maximum speed. In related arts, virtual automobiles typically adopt an automatic gear shifting mode, that is, a client installed and running in a computer device (such as a terminal) automatically shifts the gear of the virtual automobile.

By using the automatic mode to automatically control the gear of the virtual automobile, there are situations that the user cannot manually control the gear of the virtual automobile, resulting in the inability to accurately control the virtual automobile.

### SUMMARY

This application provides a method and apparatus for shifting a gear of a virtual vehicle, a device, and storage medium, which can achieve accurate control of the virtual vehicle. The technical solutions are as follows:

According to one aspect, this application provides a method for shifting a gear of a virtual vehicle in a virtual environment executed by a computer device and the method includes:
displaying, in a user interface, the virtual vehicle in a travel state in the virtual environment, the virtual vehicle correspondingly having at least two gears;
acquiring terminal motion data from a motion sensor in the computer device;
determining a tapping operation on a surface of a display of the computer device according to the terminal motion data; and
in response to a gear shifting instruction triggered by the tapping operation, performing at least one of upshifting the gear of the virtual vehicle and downshifting the gear of the virtual vehicle according to the gear shifting instruction.

According to another aspect, this application provides a computer device that includes a processor and a memory. The memory has at least one program stored therein. The at least one program, when loaded and executed by the processor, causes the computer device to implement the method for shifting the gear of the virtual vehicle in the virtual environment according to the above aspect.

According to another aspect, this application provides a non-transitory computer-readable storage medium. The computer-readable storage medium has at least one program stored therein. The at least one program, when loaded and executed by a processor of a computer device, causes the computer device to implement the method for shifting the gear of the virtual vehicle in the virtual environment according to the above aspect.

The technical solutions provided in this application have at least the following beneficial effects.

Through a tapping operation on the computer device (terminal), shifting the gear of the virtual vehicle (virtual automobile), that is, upshifting the gear of the virtual vehicle and/or downshifting the gear of the virtual vehicle, can be triggered. The tapping operation is different from a touch operation on a display screen of the terminal, and will not influence or be influenced by the touch operation of a user on the display screen, thus achieving high operation accuracy. Therefore, the user can accurately control the gear of the virtual vehicle through the tapping operation, thus achieving the accurate control of the virtual vehicle.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a schematic diagram of a relationship between vehicle speed and engine speed according to an exemplary embodiment of this application.

FIG. 2 is a schematic diagram of a state of an object in a three-dimensional (3D) space according to an exemplary embodiment of this application.

FIG. 3 is a schematic structural diagram of a terminal according to an exemplary embodiment of this application.

FIG. 4 is a structural block diagram of a computer system according to an exemplary embodiment of this application.

FIG. 5 is a schematic diagram of a process of shifting a gear of a virtual automobile according to an exemplary embodiment of this application.

FIG. 6 is a schematic flowchart of a method for shifting a gear of a virtual vehicle according to an exemplary embodiment of this application.

FIG. 7 is a schematic diagram of a user interface according to an exemplary embodiment of this application.

FIG. 8 is a schematic flowchart of a method for shifting a gear of a virtual vehicle according to an exemplary embodiment of this application.

FIG. 9 is a schematic diagram of a user interface according to an exemplary embodiment of this application.

FIG. 10 is a schematic diagram of virtual sampling points according to an exemplary embodiment of this application.

FIG. 11 is a schematic diagram of a steering wheel of a race car according to an exemplary embodiment of this application.

FIG. 12 is a schematic diagram of virtual sampling points according to an exemplary embodiment of this application.

FIG. 13 is a schematic diagram of an operation process of shifting a gear according to an exemplary embodiment of this application.

FIG. 14 is a schematic structural diagram of an apparatus for shifting a gear of a virtual vehicle according to an exemplary embodiment of this application.

FIG. 15 is a schematic structural diagram of a terminal according to an exemplary embodiment of this application.

Accompanying drawings here are incorporated into the specification and constitute a part of this specification, illustrate embodiments that conform to this application, and are used for describing the principle of this application together with this specification.

### DESCRIPTION OF EMBODIMENTS

To make the objectives, technical solutions, and advantages of this application clearer, the following further describes the embodiments of this application in detail with reference to the accompanying drawings. First, terms involved in the embodiments of this application will be introduced below.

Virtual environment: It is a virtual environment displayed (or provided) when an application program runs on a terminal. The virtual environment may be a simulated environment of the real world, a semi-simulated and semi-fictional environment, or a completely fictional environment. The virtual environment may be any one of a 2D virtual environment, a 2.5D virtual environment, and a 3D virtual environment, which is not limited in the embodiment of this application.

Virtual vehicle: It is at least one movable object controlled by a user in a virtual environment. The virtual vehicle may be a vehicle that simulates a vehicle in the real world, a semi-simulated and semi-fictional vehicle, or a completely fictional vehicle. The virtual vehicle includes at least one of a vehicle in the airspace, a vehicle in the water area, and a vehicle on the land. Each virtual vehicle has its own shape and volume in the virtual environment, and occupies some space in the virtual environment. This application is described mainly by taking the virtual vehicle being a virtual automobile as an example.

User Interface (UI) control: It is any visual control or element that can be seen on a user interface of an application program, for example, a picture, an input box, a text box, a button, a label, or another control. Some UI controls respond to an operation of a user.

Manual transmission: In the real world, manual transmission refers to a manual shift mechanical transmission (also known as MT) used in automobiles. For manual transmission automobiles, a driver can manually shift a gear lever to change the gear engagement position inside the transmission, thus changing a transmission ratio and achieving the purpose of changing the automobile speed. The manual transmission in this application refers to the operation mode in which the gear of the virtual vehicle (virtual automobile) is changed by the user's operation, thus changing the transmission ratio of the virtual vehicle to adjust the output speed of the virtual vehicle (such as the speed of the virtual automobile).

Gearbox (transmission): The function of the gearbox may be expressed by the following formula:

$${N}_{wheel} = \frac{{N}_{eng}}{{r}_{trans} \times {r}_{final}} ;$$

where N represents the speed, and r represents the reduction ratio. N_{wheel} represents the wheel speed, N_{eng} represents the speed of an engine crankshaft (engine speed), rₜᵣₐₙₛ represents the variable (different gears) reduction ratio of the gearbox, and r_{final} represents other non-variable reduction ratio parts in a powertrain. The higher the gear, the smaller the rₜᵣₐₙₛ, and the smaller the N_{eng} required to maintain the same N_{wheel}.

Upshifting/downshifting: If the accelerator of the automobile (virtual vehicle) is not pressed after downshifting, it will slow down. If the accelerator of the automobile is pressed after downshifting, the speed can be increased faster to achieve acceleration. Downshifting the gear of the automobile can increase the torque and improve the acceleration ability. Upshifting the gear of the automobile can increase its maximum speed of the automobile. Maximum speed refers to the highest speed (engine speed) that the automobile can reach.

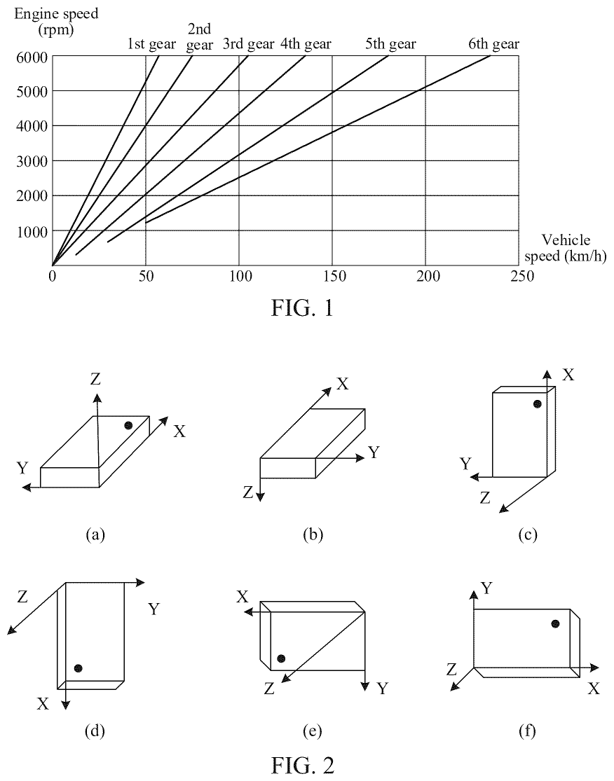

Exemplarily, FIG. 1 is a schematic diagram of a relationship between vehicle speed and engine speed according to an exemplary embodiment of this application. Referring to FIG. 1, the higher the gear of the automobile, the faster the speed at the same engine speed, so the main purpose of upshifting is to increase the maximum speed of the automobile. The lower the gear of the automobile, the faster the engine speed at the same speed, so the main purpose of downshifting is to improve the acceleration ability of the automobile.

6-Dimensional (6D) detection: FIG. 2 is a schematic diagram of a state of an object in a 3D space according to an exemplary embodiment of this application. Referring to FIG. 2, the objects in 3D space (such as a mobile phone) may have six directions based on spatial coordinate axes, as shown in (a) to (f) of FIG. 2. Based on this, a hardware device (such as a terminal) may obtain its current spatial orientation information and develop some related interactive operation applications, such as “tapping”, “flipping”, etc.

The method provided in this application can be applied to an application program with a virtual environment and a virtual vehicle. Exemplarily, an application program that supports a virtual environment is an application program in which a user can control the movement of the virtual vehicle in the virtual environment. Exemplarily, the method provided in this application can be applied to: any program of a Virtual Reality (VR) application program, an Augmented Reality (AR) program, a 3D map program, a VR game, an AR game, a First-Person Shooting (FPS) game, a Third-Person Shooting (TPS) game, a Multiplayer Online Battle Arena (MOBA) game, and a Simulation Game (SLG). Exemplarily, the game in the virtual environment is composed of maps of one or more game worlds. The virtual environment in the game can simulate the real-world scene, and the user can control the virtual character in the game to carry out actions such as walking, running, jumping, shooting, combating, and driving in the virtual environment. The virtual vehicle can also be controlled to travel in the virtual environment. The interactivity is strong. Multiple users can be teamed online for competitive games.

In some embodiments, the application program may be a shooting game, a speed competition game, an automobile racing game, a role-playing game, an adventure game, a sandbox game, a battle arena game, or the like. The client may support at least one of Windows operating system, Apple's operating system, Android operating system, IOS operating system, and LINUX operating system. Clients of different operating systems may be interconnected. In some embodiments, the client is a program adapted to a mobile terminal with a touch screen. For example, the method for shifting the gear of the virtual vehicle provided in the embodiment of this application may be applied to application programs that support automobile racing games, where the player can control the virtual vehicle to participate in virtual speed competitions. For another example, the method for shifting the gear of the virtual vehicle provided in the embodiment of this application may be applied to application programs that support role-playing games, where the player can control the virtual vehicle to move in a virtual scene to meet the needs for roaming and sightseeing.

In some embodiments, the client is an application program developed based on a 3D engine. For example, the 3D engine is a Unity engine. The terminal in this application may be a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, or the like. A client that supports the virtual environment, such as a client of an applicant program that supports a 3D virtual environment, is installed and run in the terminal. The application program may be any one of a Battle Royale (BR) game, a VR application program, an AR program, a 3D map program, a TPS game, an FPS game, an MOBA game, an automobile racing game, and a speed competition game. In some embodiments, the application program may be a standalone application program, such as a standalone 3D game program, or may be an online application program.

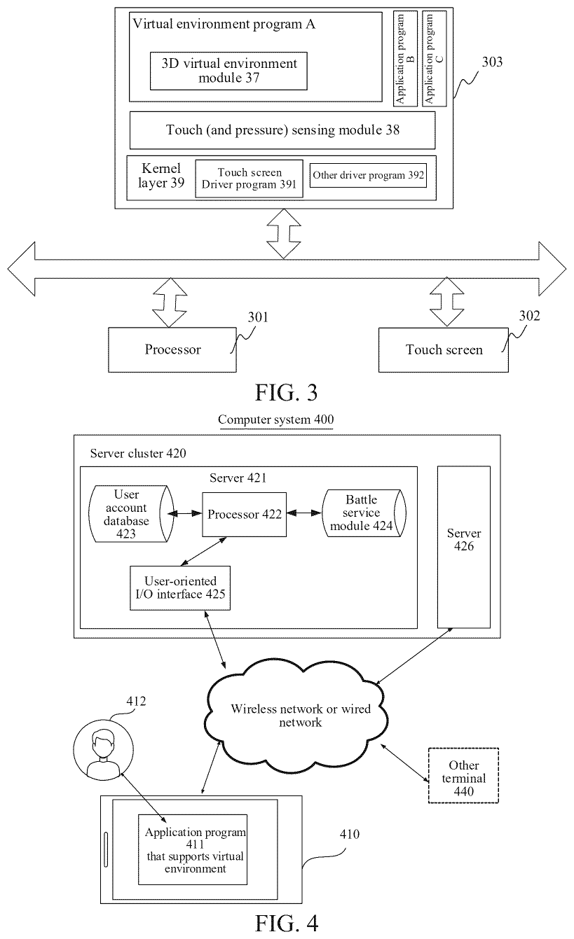

FIG. 3 is a schematic structural diagram of a terminal according to an exemplary embodiment of this application. The terminal includes a processor 301, a touch screen 302, and a memory 303. The processor 301 may be at least one of a single-core processor, a multi-core processor, an embedded chip, and a processor with instruction execution capability. The touch screen 302 includes a regular touch screen or a pressure-sensitive touch screen. The regular touch screen can measure pressing or sliding operations applied to the touch screen 302. The pressure-sensitive touch screen can measure pressing force applied to the touch screen 302. The memory 303 stores a program that can be executed by the processor 301. Exemplarily, the memory 303 stores a virtual environment program A, an application program B, an application program C, a touch (and pressure) sensing module 38, and a kernel layer 39 of an operating system. The virtual environment program A is an application program developed based on a 3D virtual environment module 37. In some embodiments, the virtual environment program A includes, but is not limited to, at least one of a game program, a VR program, a 3D map program, and a 3D presentation program developed by the 3D virtual environment module (also referred to as virtual environment module) 37. For example, when the operating system of the terminal is Android operating system, the virtual environment program A is developed by using Java programming language and C# language. For another example, when the operating system of the terminal is IOS operating system, the virtual environment program A is developed by using Object-C programming language and C# language. The 3D virtual environment module 37 is a module that supports multiple operating system platforms. Exemplarily, the 3D virtual environment module may be used for program development in multiple fields such as game development, Virtual Reality (VR), and 3D maps. The specific types of the 3D virtual environment module 37 are not limited in the embodiment of this application. The touch (and pressure) sensing module 38 is a module for receiving a touch event (and pressure touch events) reported by a touch screen driver program 391, The touch sensing module may not have a pressure sensing function and does not receive a pressure touch event. The touch event includes a type and coordinate value of the touch event. The type of the touch event includes, but is not limited to, touch start event, touch movement event, and touch drop event. The pressure touch event includes a pressure value and coordinate value of the pressure touch event. The coordinate value is configured for indicating a touch position of a pressure touch operation on a display screen. Exemplarily, the kernel layer 39 includes a touch screen driver program 391 and another driver program 392. The touch screen driver program 391 is a module configured to detect a pressure touch event. When the touch screen driver program 391 detects the pressure touch event, it transmits the pressure touch event to the touch (and pressure) sensing module 38.

The other driver program 392 may be a driver program related to the processor 301, a driver program related to the memory 303, a driver program related to a network component, a driver program related to a sound component, a driver program related to an acceleration measurement component, or the like. Those skilled in the art may know that the above is only a general exemplary description of the structure of the terminal. In different embodiments, the terminal may have more or fewer components. For example, the terminal may further include an acceleration sensor, a gyroscope sensor, a power supply, and the like.

FIG. 4 is a structural block diagram of a computer system according to an exemplary embodiment of this application. The computer system 400 includes a terminal 410 and a server cluster 420. A client 411 supporting a virtual environment is installed and run on the terminal 410, and the client 411 may be an application program supporting the virtual environment. When the client 411 runs in the terminal, a user interface of the client 411 is displayed on a screen of the terminal 410. The client may be any one of an FPS game, a TPS game, an MOBA game, a competitive game, an SLG, a speed competition game, and an automobile racing game. In this embodiment, description is made by taking the client 411 being an automobile racing game as an example. The terminal 410 is a terminal used by a first user 412. The first user 412 controls the travel of a virtual vehicle located in a virtual environment by using the terminal 410. The control of the virtual vehicle by the first user 412 includes forwarding, reversing, turning left, turning right, upshifting, downshifting, accelerator stepping, braking, acceleration using virtual props, etc. A device type of the terminal 410 includes at least one of a smart phone, a tablet computer, an e-book reader, an MP3 player, an MP4 player, a laptop portable computer, and a desktop computer.

FIG. 4 only illustrates one terminal. However, multiple other terminals 440 may exist in different embodiments. In some embodiments, there is at least one other terminal 440 which is a terminal corresponding to a developer. A developing and editing platform of the client having a virtual environment is installed on the other terminal 440. The developer may edit and update the client on the other terminal 440, and transmit an updated client installation package to the server cluster 420 via a wired or wireless network. The terminal 410 may download the client installation package from the server cluster 420 to update the client. The terminal 410 and the other terminals 440 are connected to the server cluster 420 through a wireless network or a wired network. The server cluster 420 includes at least one of one server, multiple servers, a cloud computing platform, and a virtualization center. The server cluster 420 is configured to provide a background service for the client supporting the 3D virtual environment. In some embodiments, the server cluster 420 is responsible for primary computing work, and the terminals are responsible for secondary computing work; or the server cluster 420 is responsible for secondary computing work, and the terminals are responsible for primary computing work; or the server cluster 420 and the terminals perform collaborative computing by using a distributed computing architecture. In some embodiments, the terminals and the server are both computer devices. In an example, the server cluster 420 includes a server 421 and a server 426. The server 421 includes a processor 422, a user account database 423, a battle service module 424, and a user-oriented Input/Output Interface (I/O interface) 425. The processor 422 is configured to load instructions stored in the server 421, and process data in the user account database 423 and the battle service module 424. The user account database 423 is configured to store data of user accounts used by the terminal 410 and the other terminal 440, such as avatars of the user accounts, nicknames of the user accounts, virtual vehicles owned by the user accounts, and service areas to which the user accounts belong. The battle service module 424 is configured to provide multiple battle rooms for users to battle. The user-oriented I/O interface 425 is configured to establish communication with the terminal 410 through a wireless network or a wired network for data exchange.

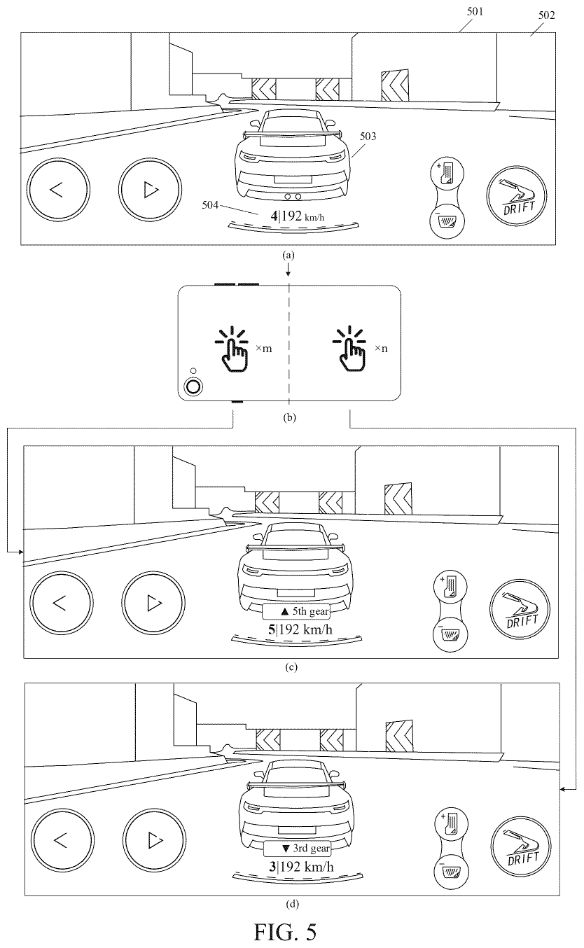

Based on the above introduction of the virtual environment and the description of the implementation environment, the following will describe a method for shifting a gear of a virtual vehicle according to an embodiment of this application. FIG. 5 is a schematic diagram of a process of shifting a gear of a virtual automobile according to an exemplary embodiment of this application. Description will be made by taking the virtual vehicle being a virtual automobile, the computer device being a terminal, and a client being installed and run in the terminal as an example. Referring to (a) of FIG. 5, a client displays a user interface 501. The user interface 501 displays a virtual environment 502 and a virtual automobile 503 in a travel state. The user interface 501 further displays a current gear 504 of the virtual automobile 503. For example, the current gear of the virtual automobile 503 is 4th gear. Referring to (b) of FIG. 5, when the gear shifting mode of the virtual automobile 503 is a manual mode, the terminal responds to consecutive m first tapping operations with a tapping position located on a first side (a left side in (b)) of a back surface of the terminal and a tapping direction facing towards the inside of the terminal, and the client determines to trigger a first gear shifting instruction once. Referring to (c) of FIG. 5, the terminal responds to the first gear shifting instruction once, and the client displays upshifting the gear 504 of the virtual automobile 503 by one gear. For example, the gear 504 of the virtual automobile 503 is upshifted from 4th gear to 5th gear. Referring to (b) of FIG. 5, when the gear shifting mode of the virtual automobile 503 is a manual mode, the terminal responds consecutive n second tapping operations with a tapping position located on a second side (a right side in (b)) of a back surface of the terminal and a tapping direction facing towards the inside of the terminal, and the client determines to trigger a second gear shifting instruction once. Referring to (d) of FIG. 5, the terminal responds the second gear shifting instruction once, and the client displays downshifting the gear 504 of the virtual automobile 503 by one gear. For example, the gear 504 of the virtual automobile 503 is downshifted from 4th gear to 3rd gear.

Exemplarily, the back surface of the terminal refers to a surface of the terminal opposite to a surface where the display screen is located. In some embodiments, continuously referring to (b) of FIG. 5, the first side (left side in (b)) of the back surface of the terminal corresponds to the right side of the surface where the display screen is located (mirror relationship), and the second side (right side in (b)) of the back surface of the terminal corresponds to the left side of the surface where the display screen is located. Both m and n are 2. In some embodiments, when the gear shifting mode of the virtual automobile is an automatic mode, the terminal responds consecutive tapping operations, and the client will display, in the user interface 501, switching the gear shifting mode of the virtual automobile to a manual mode. The consecutive tapping operations are operations of tapping the terminal for consecutive x times. In some embodiments, x is 3. Through the tapping operation on the terminal, shifting the gear of the virtual automobile, that is, upshifting the gear of the virtual automobile and/or downshifting the gear of the virtual automobile, can be triggered. Since the tapping operations on the terminal in this embodiment of this application have corresponding tapping positions, tapping directions, tapping forces and the like, and the number of the tapping operations may be consecutive m, n, or x, while the touch operations on the display screen of the terminal are usually single touch or long press touch operations, the tapping operations in this embodiment of this application are different from the touch operations on the display screen of the terminal, and will not influence or be influenced by the user's touch operations on the display screen, thus achieving high operation accuracy. Therefore, the user can accurately control the gear of the virtual automobile through the tapping operation, thus achieving the accurate control of the virtual automobile.

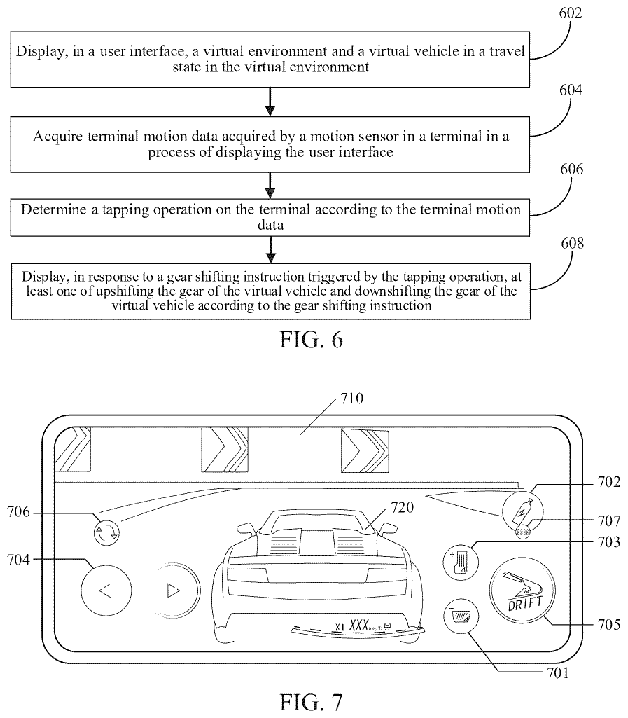

FIG. 6 is a schematic flowchart of a method for shifting a gear of a virtual vehicle according to an exemplary embodiment of this application. The method may be executed by a computer device and may be specifically used for the terminal or the client on the terminal as shown in FIG. 4. Referring to FIG. 6, the method includes the following operations:

Operation 602: Display, in a user interface, a virtual environment and the virtual vehicle in a travel state in the virtual environment in a user interface.

The user interface refers to any interface in the client that can provide the function of controlling the travel of the virtual vehicle. Exemplarily, the user interface is an interface displayed when a user account controls the virtual vehicle to compete in speed with virtual vehicles controlled by other user accounts, or an interface displayed when the user account controls the travel of the virtual vehicle to complete game tasks, or an interface displayed when the user account controls the virtual vehicle to compete in speed with a Non-Player Character (NPC) virtual vehicle controlled by the client/server.

The virtual environment includes any one of a simulated environment of a real world, a semi-simulated semi-fictional environment, and a completely fictional environment. The virtual environment is any one of a 2D virtual environment, a 2.5D virtual environment, and a 3D virtual environment. Areas that support the travel of the virtual vehicle are displayed in the virtual environment, and the virtual vehicle can travel in the areas. In some embodiments, Areas that do not support the travel of the virtual vehicle are also displayed in the virtual environment, for example, areas such as virtual streams, virtual lakes, and virtual oceans where the virtual automobile cannot travel. Exemplarily, for the virtual automobile, the areas that support the travel of the virtual vehicle include virtual roads and non-virtual roads. The virtual roads are used for simulating roads in the real world, and for example, are used for simulating roads, highways, racetracks, etc. In some embodiments, warning elements such as shoulders, signs, and travel direction guidelines are also displayed on peripheries of the virtual roads. The non-virtual roads refer to areas outside of virtual roads, such as virtual lawns, virtual sidewalks, and virtual forests.

The virtual vehicle refers to at least one movable object controlled by a user account in the virtual environment. The virtual vehicle may be a vehicle that simulates a vehicle in the real world, a semi-simulated and semi-fictional vehicle, or a completely fictional vehicle. The virtual vehicle is a vehicle that is virtual and supports gear shifting. The virtual vehicle correspondingly has at least two gears. For example, if the virtual vehicle is a virtual automobile, the corresponding gears of the virtual vehicle are respectively 1st gear, 2nd gear, 3rd gear, 4th gear, 5th gear, and 6th gear. In some embodiments, the virtual vehicle includes at least one of a vehicle traveling (flying) in the airspace, a vehicle traveling (navigating) in the water area, and a vehicle traveling on the land. For example, when the virtual vehicle is a virtual automobile, the virtual automobile includes a virtual car, sports car, formula race car, kart, bus, electric vehicle, motorcycle, etc.

In some embodiments, the user account controls the behavior of a driver of the virtual vehicle, thus controlling the travel of the virtual vehicle. For example, controlling the driver of the virtual vehicle to perform behaviors such as steering, upshifting, downshifting, accelerator stepping, and braking. Alternatively, the user account directly controls the travel of the virtual vehicle. Exemplarily, the control of the virtual vehicle by the user account includes controlling the virtual vehicle to forward, reverse, turn left, turn right, upshift, downshift, step on the accelerator, brake, drift, use virtual props (such as acceleration props), etc.

Exemplarily, FIG. 7 is a schematic diagram of a user interface according to an exemplary embodiment of this application. Taking the virtual vehicle being a virtual automobile as an example, referring to FIG. 7, a virtual automobile 720 is displayed in a user interface 710, and the virtual automobile 720 travels in a virtual environment displayed in the user interface 710. The user interface 710 includes at least one of the following controls: a brake control 701, an energy control 702, an accelerator control 703, a direction control 704, a handbrake control 705, or a reset control 706. The function of each control is described as follows. The brake control 701 is configured to provide a function of controlling the speed of the virtual automobile 720 to decrease. The terminal responds to a trigger operation on the brake control 701, and the client will control the speed of the virtual automobile 720 to decrease. For example, in response to a single-click/tap operation on the brake control 701, and the terminal controls the speed of the virtual automobile 720 to decrease accordingly. In addition, when the brake control 701 is pressed long, the speed of the virtual automobile 720 is controlled to continuously decrease. Moreover, the speed at which the speed of the virtual automobile 720 decreases may be determined by the touch force and/or touch duration on the brake control 701. For example, the larger the touch force (e.g., exceeding a force threshold), the faster the speed of the virtual automobile 720 decreases; the longer the touch duration (e.g., exceeding a duration threshold), the faster the speed of the virtual automobile 720 decreases. The energy control 702 is configured to indicate the storage amount of acceleration energy of the virtual automobile 720. The terminal responds to a trigger operation on the energy control 702, the client may consume one unit of acceleration energy to provide an additional acceleration function for the virtual automobile 720 (different from acceleration by stepping on the accelerator). In some embodiments, a storage amount control 707 for acceleration energy is displayed on the periphery of energy control 702, and the storage amount control 707 is configured to indicate the storage amount of acceleration energy corresponding to the virtual automobile 720. Taking the acceleration energy being nitrogen as an example, the energy control 702 is configured to indicate the storage amount of nitrogen available for accelerating the virtual automobile 720. For example, the energy control 702 is configured to indicate the storage amount of a bottle of nitrogen. The storage amount control 707 is configured to indicate the number of nitrogen bottles corresponding to the virtual automobile 720. The terminal responds to a trigger operation on the energy control 702, and the client displays consuming one bottle of nitrogen to accelerate the virtual automobile 720, and displays prompt information of consuming one bottle of nitrogen in the user interface 710. The accelerator control 703 is configured to provide a function of controlling the speed (engine speed) of the virtual automobile 720 to increase. The terminal responds to a trigger operation on the accelerator control 703, and the client control the virtual automobile 720 to accelerate. The trigger operation may be at least one of a single-click/tap operation, a double-click/tap operation, a touch operation, a press-and-hold operation, and the like. In some embodiments, the terminal responds to a trigger operation on the accelerator control 703, and the accelerator corresponding to the virtual automobile 720 will automatically maintain a pressed state, so that the virtual automobile 720 maintains a continuous accelerating state. For example, when the user clicks/taps on the accelerator control 703 and then releases, the virtual automobile 720 enters a continuous accelerating state.

In some embodiments, when the virtual automobile 720 is in a continuous accelerating state, the brake control 701 is further configured to implement at least one of functions of stopping accelerating, decelerating, and reversing the virtual automobile 720. In some embodiments, after the virtual automobile enters a continuous accelerating state, the terminal responds to a trigger operation on the brake control 701, and the client controls the virtual automobile 720 to stop accelerating, for simulating a state that the accelerator pops up. When the trigger operation on the brake control 701 is a single-click/tap operation, the client controls the virtual automobile 720 to stop accelerating and enter a natural decelerating state. The natural decelerating state refers to a state that the virtual automobile 720 continuously decelerates due to a resistance factor. The resistance factor includes at least one of road surface resistance, air resistance, and mechanical loss. When the trigger operation on the brake control 701 is a press-and-hold operation, the client controls the virtual automobile 720 to stop accelerating and enter a continuously decelerating state. The continuously decelerating state refers to a state that the virtual automobile 720 continuously decelerates due to a resistance factor and a braking resistance. The braking resistance is generated based on the press-and-hold operation on the brake control 701. The road surface resistance refers to the friction force between tires of the virtual automobile 720 and the ground. The air resistance refers to the resistance experienced by the virtual automobile 720 during friction with air in the travel process. The mechanical loss refers to kinetic energy loss in a transmission apparatus of the virtual automobile 720. The magnitude of the braking resistance may be set according to actual needs. The natural decelerating state is related to the current speed, and the greater the current vehicle speed, the greater the deceleration. The speed of deceleration in the continuously decelerating state is faster than that in the natural decelerating state. For example, taking an initial speed being 100 km/h as an example, it takes 60 seconds for the virtual automobile 720 to decelerate to 0 km/h in the natural decelerating state, while only 2.5 seconds is needed in the continuous decelerating state. In some embodiments, when the virtual automobile 720 is in a continuous decelerating state, if the speed of the virtual automobile 720 decreases to 0 and the press-and-hold operation on the brake control 701 still exists, the virtual automobile 720 is controlled to enter a reversing state. The direction control 704 is configured to provide a function of controlling the travel direction (steering) of the virtual automobile 720. In some embodiments, the direction control 704 includes a left turn control and a right turn control, which are respectively configured to implement left turning and right turning of the virtual automobile 720. The handbrake control 705 is configured to provide a function of controlling the virtual automobile 720 to brake/drift. In a steady travel state (non-drifting state, such as straight travel), in response to a trigger operation on the handbrake control 705, the client controls the speed of the virtual automobile 720 to decrease. In some embodiments, the terminal responds to operations of simultaneously triggering the direction control 704 and the handbrake control 705, the virtual automobile 720 enters a drifting state. For example, on a left turning bend, the direction control 704 is controlled to turn left and the handbrake control 705 is triggered to drift over the bend, or in a right turning bend, the direction control 704 is controlled to turn right and the handbrake control 705 is triggered to drift over the bend. The reset control 706 is configured to provide a function of restarting the virtual automobile 720. The terminal responds to a trigger operation on the reset control 706, and the client controls the virtual automobile 720 to be displayed again on an open road surface on the periphery of the current virtual environment, so as to control the virtual automobile 720 to restart. The reset control 706 is typically used in a process of detrapping the virtual automobile 720.

In FIG. 7, the client achieves triggering relevant functions of controlling the virtual vehicle to travel through human-machine interaction operations (signals) detected by the display screen of the terminal. Besides, the client may also trigger relevant functions of controlling the virtual vehicle to travel through signals generated by control components integrated on the terminal or external control devices connected to the terminal. For example, the travel of the virtual vehicle may be controlled through signals generated by joysticks and physical buttons integrated on the terminal, and external devices such as mice, keyboards, and game pads connected to the terminal. In some embodiments, the terminal is connected to the external devices in a wired or wireless mode. The way of controlling the virtual vehicles to travel is not limited in the embodiment of this application.

Operation 604: Acquire terminal motion data acquired by a motion sensor in a terminal in a process of displaying the user interface.

The motion sensor is a sensor configured to detect the motion state of the terminal. Exemplarily, the motion sensor includes at least one of an acceleration sensor and a gyroscope sensor. The acceleration sensor is a sensor configured to measure acceleration. The gyroscope sensor is a sensor configured to determine the direction of a moving object. The type of the motion sensor is not limited in the embodiment of this application.

The motion state of the terminal includes at least one of pose changes of the terminal and movement situations (such as movement direction and movement speed) of the terminal. When the terminal is subjected to an external force causing a change in its motion state, the output data of the motion sensor in the terminal will also change accordingly to reflect the change in the motion state of the terminal.

Operation 606: Determine a tapping operation on the terminal according to the terminal motion data.

The tapping operation is an operation of tapping a surface of the terminal. In some embodiments, the tapping operation is triggered by at least one of tapping a surface where a display screen of the terminal is located, tapping a back surface of the terminal, and tapping a surrounding side frame of the terminal. The back surface of the terminal refers to a surface of the terminal opposite to the surface where the display screen is located. That is, the tapping position of the tapping operation includes at least one of the surface where the display screen is located, the back surface of the terminal, and the surrounding side frame of the terminal. The tapping direction of the tapping operation faces towards the inside of the terminal.

For foldable phones, there may be multiple display screens, in which case the surface where the display screen is located includes a surface where a display screen currently used by the user is located, that is, the surface where the display screen displaying the user interface is located.

The client determines whether there is a tapping operation currently and at least one of the tapping position, the tapping direction, and the tapping force of the tapping operation based on data acquired by the motion sensor in the terminal. In some embodiments, the client periodically acquires the data acquired by the motion sensor to determine and obtain the tapping operation. Exemplarily, the user triggers the tapping operation by tapping the terminal with a fingertip of any finger; or the user triggers the tapping operation by tapping the terminal with a finger pulp of any finger; or the user triggers the tapping operation by tapping the terminal with a finger knuckle of any finger. The user may also trigger the tapping operation by tapping the terminal with other parts of the body or by using an instrument, which is not limited in the embodiment of this application.

When the client controls the travel of the virtual vehicle through a signal generated by an external control device connected to the terminal, the client may also receive the tapping operation through the external control device. For example, when the user taps a game pad, the client acquires data through a motion sensor in the game pad to determine and obtain the tapping operation.

Operation 608: Display, in response to a gear shifting instruction triggered by the tapping operation, at least one of upshifting the gear of the virtual vehicle and downshifting the gear of the virtual vehicle according to the gear shifting instruction.

The client displays upshifting the gear of the virtual vehicle and/or downshifting the gear of the virtual vehicle according to the gear shifting instruction. One gear shifting instruction corresponds only to one of upshifting the gear of the virtual vehicle and downshifting the gear of the virtual vehicle. In some embodiments, the gear shifting instruction includes a first gear shifting instruction and a second gear shifting instruction. The first gear shifting instruction corresponds to upshifting the gear of the virtual vehicle, and the second gear shifting instruction corresponds to downshifting the gear of the virtual vehicle. That is, when the first gear shifting instruction is triggered once, the client displays upshifting the gear of the virtual vehicle by one gear. And/or, when the second gear shifting instruction is triggered once, the client displays downshifting the gear of the virtual vehicle by one gear.

The first gear shifting instruction and the second gear shifting instruction are triggered through different tapping operations. In some embodiments, different tapping operations include tapping operations with different tapping positions, tapping operations with different tapping directions, and tapping operations with different tapping positions and directions. For example, a tapping operation on a first side of the back surface of the terminal may trigger the first gear shifting instruction, and a tapping operation on a second side of the back surface of the terminal may trigger the second gear shifting instruction. The first side of the back surface of the terminal refers to a side of the back surface of the terminal opposite to a right side of the display screen, and the second side of the back surface of the terminal refers to a side of the back surface of the terminal opposite to a left side of the display screen. In some embodiments, one tapping operation may trigger the gear shifting instruction once, or multiple consecutive tapping operations may trigger the gear shifting instruction once. In this embodiment of this application, “multiple consecutive” refers to multiple times within a preset time period, that is, when the client obtains multiple consecutive tapping operations within the preset time period, the gear shifting instruction will be triggered once. In some embodiments, the tapping operation may trigger the gear shifting instruction only when the tapping force meets a condition (for example, the tapping force is greater than a force threshold), because if the gear shifting instruction is triggered when the tapping force is small, there may be a possibility of false triggering. Moreover, since the tapping operation is detected through the motion sensor, the situation that the tapping force is large may be a situation that the terminal falls or flips. The condition for the tapping force may be set by the developer or user based on actual needs. In some embodiments, the client may also trigger the gear shifting instruction in other ways, for example, through human-machine interaction operations detected on the display screen of the terminal, which is not limited in the embodiment of this application. In the method provided in this embodiment, the gear shifting instruction is triggered only when the force and direction of the tapping operation meet the conditions, thus preventing the gear shifting instruction from being triggered falsely.

The client will respond to the tapping operation to trigger the gear shifting instruction only when the gear shifting mode of the virtual vehicle is a manual mode. The gear shifting mode of the virtual vehicle further includes an automatic mode. The client may switch the gear shifting mode of the virtual vehicle between the manual mode and the automatic mode according to the operation of the user. For example, the gear shifting mode is defaulted to be the manual mode, and then it is switched to the automatic mode according to the operation of the user. Alternatively, the gear shifting mode is defaulted to be the automatic mode, and then it is switched to the manual mode according to the operation of the user. In some embodiments, when the gear shifting mode of the virtual vehicle is the automatic mode, the terminal responds to consecutive tapping operations on the terminal, and the client will display switching the gear shifting mode of the virtual vehicle to the manual mode. The consecutive tapping operations are operations of tapping the terminal for consecutive x times, where x is a positive integer. In an example, x may be set to 3.

To sum up, in the method provided in this embodiment, through the tapping operation on the terminal, shifting the gear of the virtual vehicle, that is, upshifting the gear of the virtual vehicle and/or downshifting the gear of the virtual vehicle, can be triggered. The tapping operation is different from a touch operation on a display screen of the terminal, and will not influence or be influenced by the touch operation of a user on the display screen, thus achieving high operation accuracy. Therefore, the user can accurately control the gear of the virtual vehicle through the tapping operation, thus achieving the accurate control of the virtual vehicle.

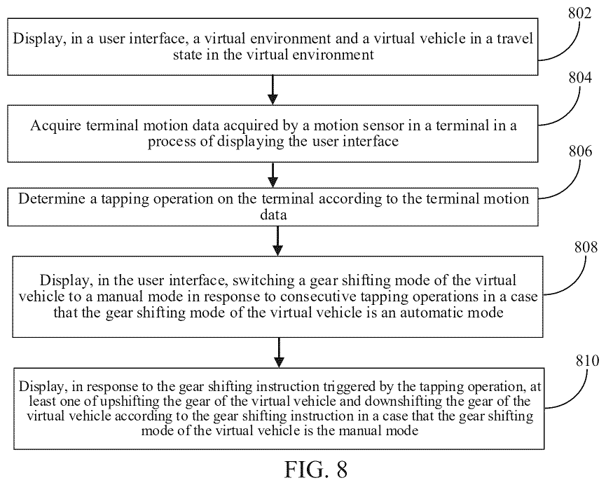

FIG. 8 is a schematic flowchart of a method for shifting a gear of a virtual vehicle according to an exemplary embodiment of this application. The method may be used for the terminal or the client on the terminal shown in FIG. 4. Referring to FIG. 8, the method includes the following operations:

Operation 802: Display, in a user interface, a virtual environment and the virtual vehicle in a travel state in the virtual environment in a user interface.

The user interface is any interface in the client that can provide the function of controlling the travel of the virtual vehicle. The user interface is either a horizontal or vertical user interface. The horizontal user interface is a user interface with the length of a horizontal side being greater than the length of a vertical side, while the vertical user interface is a user interface with the length of a horizontal side being less than the length of a vertical side.

Areas that support the travel of the virtual vehicle are displayed in the virtual environment, and the virtual vehicle can travel in the areas. The virtual vehicle may be a vehicle that simulates a vehicle in the real world, a semi-simulated and semi-fictional vehicle, or a completely fictional vehicle. Exemplarily, the control of the virtual vehicle by the user account includes controlling the virtual vehicle to forward, reverse, turn left, turn right, upshift, downshift, step on the accelerator, brake, drift, use virtual props (such as acceleration props), etc.

Operation 804: Acquire terminal motion data acquired by a motion sensor in a terminal in a process of displaying the user interface.

The motion sensor is a sensor configured to detect the motion state of the terminal. Exemplarily, the motion sensor includes at least one of an acceleration sensor and a gyroscope sensor. The acceleration sensor is a sensor configured to measure acceleration. The gyroscope sensor is a sensor configured to determine the direction of a moving object. The type of the motion sensor is not limited in the embodiment of this application.

The motion state of the terminal includes at least one of pose changes of the terminal and movement situations (such as movement direction and movement speed) of the terminal. When the terminal is subjected to an external force causing a change in its motion state, the output data of the motion sensor in the terminal will also change accordingly to reflect the change in the motion state of the terminal.

Operation 806: Determine a tapping operation on the terminal according to the terminal motion data.

The tapping operation is an operation of tapping a surface of the terminal. In some embodiments, the tapping operation is triggered by at least one of tapping a surface where a display screen of the terminal is located, tapping a back surface of the terminal, and tapping a surrounding side frame of the terminal. The back surface of the terminal refers to a surface of the terminal opposite to the surface where the display screen is located.

The client determines whether there is a tapping operation currently based on data acquired by the motion sensor in the terminal, thus receiving the tapping operation. For example, when the data acquired by the motion sensor changes, that is, when the pose of the terminal changes, the client receives a tapping operation. The terminal may further determine at least one of the tapping position, the tapping direction, and the tapping force based on the data acquired by the motion sensor, thus executing subsequent operations. Exemplarily, the motion sensor includes at least one of an acceleration sensor and a gyroscope sensor. In some embodiments, the client periodically acquires the data acquired by the motion sensor to determine and obtain the tapping operation.

In some embodiments, for the virtual vehicle in a travel state, the client will receive a tapping operation to trigger the following operations of switching the gear shifting mode and shifting the gear of the virtual vehicle according to the tapping operation. For the virtual vehicle in a non-travel state, the client will not determine and receive a tapping operation. Alternatively, for the virtual vehicle in the non-travel state, the client will also determine and receive a tapping operation to trigger the following operations. Exemplarily, the travel state refers to the virtual vehicle being in a non-stationary state.

Operation 808: Display, in the user interface, switching a gear shifting mode of the virtual vehicle to a manual mode in response to consecutive tapping operations when the gear shifting mode of the virtual vehicle is an automatic mode.

The automatic mode refers to a mode that the client/server automatically controls the gear of the virtual vehicle based on the speed (acceleration/deceleration) of the virtual vehicle. The manual mode refers to a mode that the client/server shifts the gear of the virtual vehicle according to the operation of the user. The client may switch the gear shifting mode of the virtual vehicle between the manual mode and the automatic mode according to the operation of the user.

The consecutive tapping operations are operations of tapping the terminal for consecutive x times, where x is a positive integer. Tapping for consecutive x times refers to tapping for x times detected within a first preset duration. The first preset duration is set by the developer or user, and x is set by the developer or user. Exemplarily, x is 3. The tapping position of each of the consecutive tapping operation may be the same or different. The tapping position includes at least one of the surface where the display screen of the terminal is located, the back surface of the terminal, and the side frame of the terminal. For example, the consecutive tapping operations are operations of tapping the back surface of the terminal for consecutive three times. In some embodiments, the consecutive tapping operations can not only switch the automatic mode to the manual mode, but also switch the manual mode back to the automatic mode. In the method provided in this embodiment, by triggering switching to the manual mode through the consecutive tapping operations when the virtual vehicle is in automatic mode, the user can flexibly switch the gear shifting mode of the virtual vehicle according to needs, thus improving the user experience.

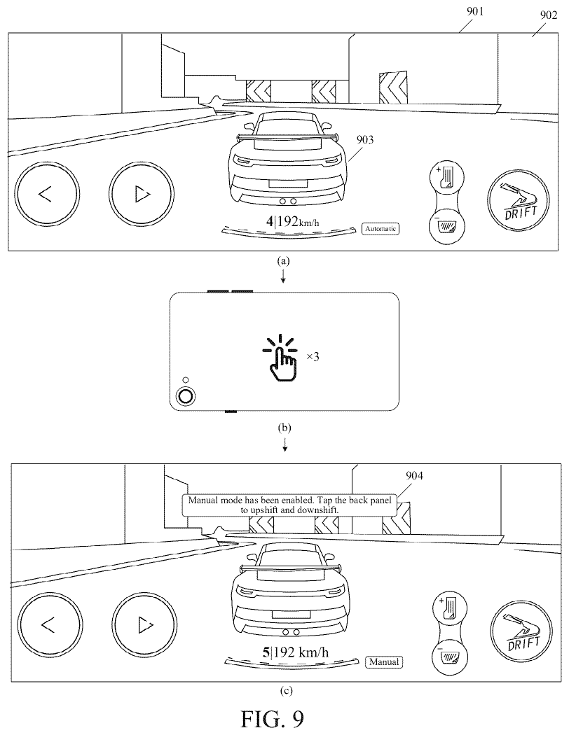

Exemplarily, FIG. 9 is a schematic diagram of a user interface according to an exemplary embodiment of this application. Taking the virtual vehicle being a virtual automobile as an example, referring to (a) of FIG. 9, a user interface 901 displayed on a client includes a virtual environment 902 and a virtual automobile 903 in a travel state in the virtual environment 902. At this time, the gear shifting mode of the virtual automobile 903 is an automatic mode. In some embodiments, the client will display information for indicating the current gear shifting mode in the user interface 901, such as “Automatic” in (a) of FIG. 9. Referring to (b) of FIG. 9, the terminal responds to receiving consecutive three tapping operations on the back surface of the terminal, the client switches the gear shifting mode of the virtual automobile 903 to the manual mode. Referring to (c) of FIG. 9, the client displays the following switching information 904 for the gear shifting mode in the user interface 901: “Manual mode has been enabled. Tap the back panel to upshift and downshift”, so as to instruct the gear shifting mode of the virtual automobile 903 to change. In some embodiments, the client will display information for indicating the current gear shifting mode in the user interface 901, such as “Manual” in (c) of FIG. 9. In some embodiments, it is determined that the tapping operation is effective only when the client determines that the force of the tapping operation meets a certain condition, so that the tapping operation triggers switching the gear shifting mode of the virtual vehicle to the manual mode or shifting the gear of the virtual vehicle. The detection of the tapping operation will be described below in detail.

Tapping the terminal will cause a change in the data of the motion sensor (acceleration sensor and/or gyroscope sensor) in the terminal. To determine a tapped state of the terminal, a stable state of the terminal needs to be defined firstly. The purpose of confirming the stable state is to reduce false determination and improve the accuracy of interactive operation determination. The specific determination process may be achieved through virtual sampling points.

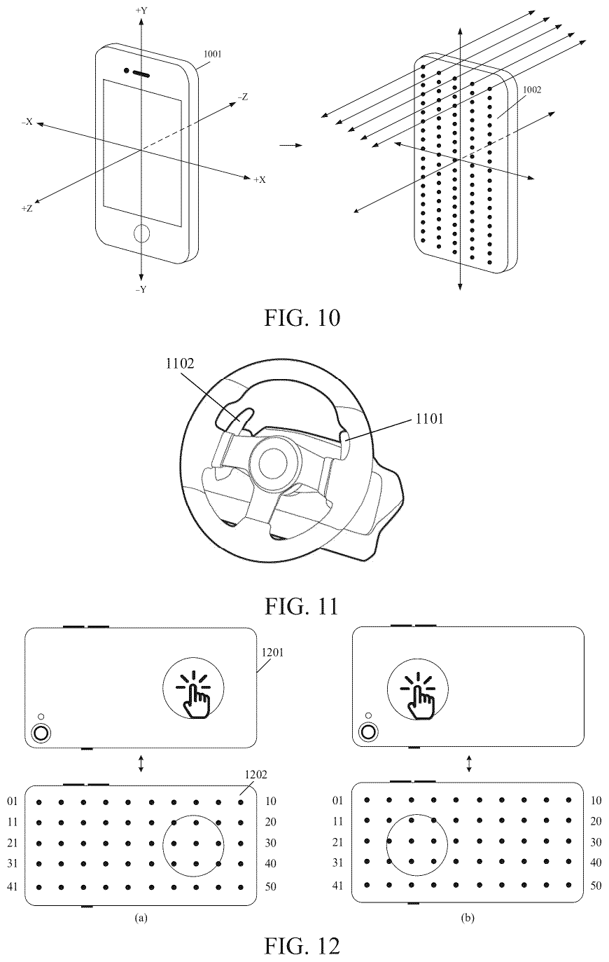

Exemplarily, FIG. 10 is a schematic diagram of virtual sampling points according to an exemplary embodiment of this application. Referring to FIG. 10, to facilitate the determination of a stable state of a terminal 1001, the terminal 1001 may be understood as a plane in 3D space (such as a plane perpendicular to the back surface of the terminal, without considering the thickness of the terminal). Multiple (for example, 100, configurable) virtual sampling points 1002 may be set on the plane. The virtual sampling points 1002 may be regarded for transmitting data (for example, acceleration of a single point) to the motion sensor built in the terminal 1001, thus obtaining the output data of the motion sensor. In other words, by determining the component of the output data of the motion sensor at each virtual sampling point 1002, the data acquired by the motion sensor at each virtual sampling point 1002, such as acceleration, can be obtained. Assuming the number of the virtual sampling points is max (A), when the absolute value of the acceleration of a virtual sampling point changes, it indicates that the terminal may experience an interaction. For example, when the user clicks/taps on the screen on the front surface of the terminal, the terminal will generate weak acceleration in space. In some embodiments, the developer may set a trigger interval a1 to b1 for confirming tapping interaction (i.e., the effectiveness of a tapping operation) in the client based on the actual testing result, where al and b1 are positive numbers, representing an interval of absolute values of acceleration of effective tapping operations. Continuously referring to FIG. 10, when the user holds the terminal 1001, the usual tapping interaction occurs on a Z-axis (direction perpendicular to the back surface of the terminal). It is set that the acceleration of the virtual sampling point on the Z-axis is Z, and the absolute value is |Z|. For the acceleration of a certain virtual sampling point, the following situations may exist:

When |Z|<a1, the terminal 1001 may experience interaction with smaller force such as click/tap; when a1≤|Z|≤b1, the terminal 1001 is in the tapping interval and an effective tapping operation may have occurred; when |Z|>b1, the terminal 1001 may experience interaction such as falling or flipping; when |Z| of a certain virtual sampling point is greater than 0, it may be considered that interaction has occurred on the virtual sampling point of the terminal 1001. On the contrary, when |Z| of all virtual sampling points is equal to 0, it may be considered that the terminal 1001 has reached a stable state.

The client may determine an acceleration component at each virtual sampling point in the Z-axis direction by determining the acceleration component of the acceleration outputted by the motion sensor at each virtual sampling point. When the absolute value of the acceleration component is within the trigger interval and the direction is a positive direction of the Z-axis, the client determines that it receives an effective tapping operation on the back surface of the terminal. For the detection principle of tapping operations on the front surface and side frame of the terminal, reference may be made to the above description, which will not be repeated here.

In some embodiments, the client may also switch the gear shifting mode of the virtual vehicle through a human-machine interaction operation on the display screen. For example, the client displays a gear shifting mode control in the user interface, and the current gear shifting mode of the virtual vehicle is displayed in the gear shifting mode control. The terminal responds to the touch operation on the gear shifting mode control, and the client switches the current gear shifting mode, for example, from the current automatic mode to the manual mode, or from the current manual mode to the automatic mode. In some embodiments, the client displays the gear shifting mode control in a set scenario, such as a scenario where the user may need to manually control the gear. The set scenario includes at least one of the following: a distance between the virtual vehicle and an opponent virtual vehicle in the virtual environment being less than a first distance threshold, and a distance between the virtual vehicle and a bent road section in the virtual environment being less than a second distance threshold.

In some embodiments, the client may also predict the time of displaying the gear shifting mode control through a machine learning model. The machine learning model is obtained by training manually labeled data. The manually labeled data include manually labeled game parameters for time periods when the manual mode needs to be executed. The game parameters are configured for reflecting the operation situation of a game, such as a current game mode (ranking mode, regular matching mode, or task completion mode), the speed of the virtual vehicle, the type of a road where the virtual vehicle is currently located (straight road, bend, U-shaped bend, or continuous bend), and the distance between the virtual vehicle and other virtual vehicles. In the running process, the client will periodically acquire the game parameters and use the machine learning model to predict whether to enter the manual mode under the given game parameters. When a prediction result indicates a need to enter the manual mode, the client displays the gear shifting mode control or directly switch the gear shifting mode to the manual mode. When a prediction result indicates no need to enter the manual mode and the current gear shifting mode is the manual mode, the client displays the gear shifting mode control or directly switch the gear shifting mode to the automatic mode. This scheme may coexist with the scheme of tapping to switch the gear shifting mode.

Operation 810: Display, in response to the gear shifting instruction triggered by the tapping operation, at least one of upshifting the gear of the virtual vehicle and downshifting the gear of the virtual vehicle according to the gear shifting instruction when the gear shifting mode of the virtual vehicle is the manual mode.

The client will respond to the tapping operation to trigger the gear shifting instruction only when the gear shifting mode of the virtual vehicle is a manual mode. In some embodiments, the terminal responds to a first gear shifting instruction triggered by a first tapping operation, and the client displays upshifting the gear of the virtual vehicle; and/or the terminal responds to a second gear shifting instruction triggered by a second tapping operation, the client displays downshifting the gear of the virtual vehicle. The first tapping operation is different from the second tapping operation in at least one of tapping position, tapping direction, and tapping force.

The terminal responds to the first gear shifting instruction triggered once by consecutive m first tapping operations, and the client displays upshifting the gear of the virtual vehicle by one gear, that is, if the client detects m first tapping operations within a second preset duration, the first gear shifting instruction will be triggered once, thus upshifting the gear of the virtual vehicle by one gear, where m is a positive integer, and m and the second preset duration are set by the developer or user. The terminal displays downshifting the gear of the virtual vehicle by one gear in response to the second gear shifting instruction triggered once by consecutive n second tapping operations, that is, if the client detects n second tapping operations within a third preset duration, the second gear shifting instruction will be triggered once, thus downshifting the gear of the virtual vehicle by one gear, where n is a positive integer, and n and the third preset duration are set by the developer or user. In the method provided in this embodiment, by triggering upshifting the gear of the virtual vehicle or downshifting the gear of the virtual vehicle through different tapping operations, accurate control of the gear of the virtual vehicle can be achieved.

### When the Back Surface of the Terminal is Tapped

The terminal responds to the first tapping operation with a tapping position located on a first side of the back surface of the terminal and a tapping direction facing towards the inside of the terminal, and the client determines to trigger the first gear shifting instruction. Then, in response to the first gear shifting instruction, the client displays upshifting the gear of the virtual vehicle. The terminal responds to the second tapping operation with a tapping position located on a second side of the back surface of the terminal and a tapping direction facing towards the inside of the terminal, the client determines to trigger the second gear shifting instruction. Then, in response to the second gear shifting instruction, the client displays downshifting the gear of the virtual vehicle.

In some embodiments, the first side of the back surface of the terminal refers to a side of the back surface of the terminal opposite to a right side of a front surface of the terminal (the surface where the display screen is located); and the second side of the back surface of the terminal refers to a side of the back surface of the terminal opposite to a left side of the front surface of the terminal. Alternatively, the first side of the back surface of the terminal refers to a side of the back surface of the terminal opposite to the left side of the front surface of the terminal; and the second side of the back surface of the terminal refers to a side of the back surface of the terminal opposite to the right side of the front surface of the terminal. Alternatively, the first side of the back surface of the terminal refers to a side of the back surface of the terminal opposite to an upper side of the front surface of the terminal; and the second side of the back surface of the terminal refers to a side of the back surface of the terminal opposite to a lower side of the front surface of the terminal. Alternatively, the first side of the back surface of the terminal refers to a side of the back surface of the terminal opposite to the lower side of the front surface of the terminal; and the second side of the back surface of the terminal refers to a side of the back surface of the terminal opposite to the upper side of the front surface of the terminal. The front surface of the terminal and the back surface of the terminal are in a mirror relationship.

When upshifting by tapping is achieved through the back panel (back surface) corresponding to the right side of the front surface of the terminal and downshifting by tapping is achieved through the back panel corresponding to the left side of the front surface of the terminal, the user may conveniently shift the gear manually by tapping the back panel of the terminal. This experience is similar to the gear shifting experience through gear shifting paddles on a steering wheel of a race car. FIG. 11 is a schematic diagram of a steering wheel of a race car according to an exemplary embodiment of this application. Referring to FIG. 11, a back surface of a steering wheel of the race car is provided with a right gear shifting paddle 1101 and a left gear shifting paddle 1102. Tapping the right gear shifting paddle 1101 can upshift the gear, and tapping the left gear shifting paddle 1102 can downshift the gear. The tapping process is performed along a direction from a side of the gear shifting paddle away from the steering wheel to a side close to the steering wheel. The above gear shifting method provided in this embodiment of this application conforms to intuition and can make it easier for the user to operate racing games, thus obtaining a better gaming experience. Compared to automatic acceleration (automatic mode), the user can experience the joy of decision making in every gear shift, making the game more playable. Through the innovative design of the interactive operation for manual gear shifting, the gear shifting method provided in this embodiment of this application succinctly solves the pain point of the lack of concise manual gear shifting interaction in current racing games, thus meeting various demands of the user in racing games.

Similar to the description of operation 806 above, in some embodiments, the client needs to detect the received tapping operation in order to determine whether the tapping operation is effective (whether it can trigger the gear shifting instruction) and whether it triggers the first gear shifting instruction or the second gear shifting instruction.

In some embodiments, a motion sensor is provided in the terminal. The client acquires acceleration generated by the terminal under the tapping operation through the motion sensor, and determines an acceleration component of the acceleration at each virtual sampling point of multiple virtual sampling points. The direction of the acceleration component is a direction perpendicular to the back surface of the terminal. The multiple virtual sampling points are distributed in a dot matrix form on a plane parallel to the back surface of the terminal. For the virtual sampling points, reference may be made to the description in FIG. 10.

The client determines first virtual sampling points where the acceleration component satisfies a tapping condition from the virtual sampling points located on the first side. The client determines second virtual sampling points where the acceleration component satisfies the tapping condition from the virtual sampling points located on the second side. The tapping condition is configured for indicating that the virtual sampling point is subjected to tapping along a tapping direction. The tapping direction is a direction perpendicularly pointing to the inside of the terminal from the back surface of the terminal. Then, the client determines that the tapping operation is the first tapping operation when a first number is greater than a second number, thus triggering the first gear shifting instruction. The client determines that the tapping operation is the second tapping operation when the first number is less than the second number, thus triggering the second gear shifting instruction. The first number is a number of the first virtual sampling points, and the second number is a number of the second virtual sampling points.

In some embodiments, each virtual sampling point corresponds to an identifier, the identifiers corresponding to the virtual sampling points located on the first side have the same first feature, and the identifiers corresponding to the virtual sampling points located on the second side have the same second feature. In some embodiments, the identifier includes a serial number of the virtual sampling point and/or coordinates of the virtual sampling point (coordinates on the distribution plane). Exemplarily, when the identifier is the serial number of the virtual sampling point, the same feature refers to one or more digits of the serial numbers being the same. For example, the single digits of the serial number for the first side are 1-5, and the single digits of the serial number for the second side are 6-10 (0). When the identifier is the coordinates of the virtual sampling point, the same feature refers to the horizontal coordinates of the virtual sampling points on the first side being all greater than a certain value, and the horizontal coordinates of the virtual sampling points on the second side being all less than a certain value. Alternatively, the horizontal coordinates of the virtual sampling points on the first side are all less than a certain value, and the horizontal coordinates of the virtual sampling points on the second side are all greater than a certain value. Alternatively, the longitudinal coordinates of the virtual sampling points on the first side are all greater than a certain value, and the longitudinal coordinates of the virtual sampling points on the second side are all less than a certain value. Alternatively, the longitudinal coordinates of the virtual sampling points on the first side are all less than a certain value, and the longitudinal coordinates of the virtual sampling points on the second side are all greater than a certain value. For example, the single digits of the serial number for the first side are 1-5, and the single digits of the serial number for the second side are 6-10 (0). For example, the horizontal coordinates on the first side are all less than 50, and the horizontal coordinates on the second side are all greater than 50.

When determining the number of the first virtual sampling points and the number of the second virtual sampling points, the client may determine target virtual sampling points where the acceleration component satisfies the tapping condition from the multiple virtual sampling points. Then, the client determines that the target virtual sampling points are the first virtual sampling points when the identifiers corresponding to the target virtual sampling points have the first feature. The client determines that the target virtual sampling points are the second virtual sampling points when the identifiers corresponding to the target virtual sampling points have the second feature.

In some embodiments, it may be determined that the virtual sampling point satisfies the tapping condition when an absolute value of the acceleration component at the virtual sampling point is greater than a first threshold and less than a second threshold, and the direction of the acceleration component at the virtual sampling point is the tapping direction. For example, taking the direction perpendicularly pointing to the inside of the terminal from the back surface of the terminal as the positive direction, the client determines that the virtual sampling point satisfies the tapping condition when an absolute value of the acceleration component is greater than a first threshold and less than a second threshold, and the acceleration component is positive. Exemplarily, the first threshold is a1 described above, and the second threshold is b1 described above.

Exemplarily, FIG. 12 is a schematic diagram of virtual sampling points according to an exemplary embodiment of this application. Referring to FIG. 12, assuming that the number of virtual sampling points 1202 corresponding to a terminal 1201 is max (A)=50, in this case, all virtual sampling points 1202 may be numbered, that is, numbered as 1 to 50 in FIG. 12. When a tapping interaction occurs on the terminal 1201, as shown in (a) of FIG. 12, when the number of the virtual sampling points 1202 with single digits of 1, 2, 3, 4, and 5 of the serial numbers in the virtual sampling points 1202 that generate acceleration (satisfy the tapping condition) is greater, the position where the tapping operation occurs tends to be a right side. Contrarily, as shown in (b) of FIG. 12, when the number of the virtual sampling points 1202 with single digits of 6, 7, 8, 9, and 10 of the serial numbers is greater, the position where the tapping operation occurs tends to be a left side. Due to the characteristic posture of holding the terminal by hand, the probability of interaction near the middle is low, so it may be determined that most tapping operations have a clear bias, that is, tending to be the left side or tending to be the right side.

Detecting the tapping operation, detecting the tapping position of the tapping operation, and detecting whether the tapping operation is effective (that is, identifying whether it is the first tapping operation/second tapping operation) by the client may be implemented in two operations or combined into one operation. In the method provided in this embodiment, upshifting the gear of the virtual vehicle or downshifting the gear of the virtual vehicle is triggered through operations of tapping different positions on the back surface of the terminal. The user can selectively shifting the gear of the virtual vehicle by tapping different positions on the back surface of the terminal, thus achieving accurate control of the gear of the virtual vehicle. In the method provided in this embodiment, the gear shifting instruction triggered by the tapping operation is determined through the acceleration at the virtual sampling point, thus providing a scheme for accurately identifying the tapping operation to trigger the gear shifting instruction. In the method provided in this embodiment, whether the tapping operation is located on the first side or the second side is determined according to the identifiers of the virtual sampling points, thus providing a scheme for conveniently determining the position of the tapping operation.

### When the Side Frame of the Terminal is Tapped

The terminal responds to the first tapping operation with a tapping position located on a side frame of a third side of the terminal and a tapping direction facing towards the inside of the terminal, and the client determines to trigger the first gear shifting instruction. Then, in response to the first gear shifting instruction, the client displays upshifting the gear of the virtual vehicle.

The terminal responds to the second tapping operation with a tapping position located on a side frame of a fourth side of the terminal and a tapping direction facing towards the inside of the terminal, the client determines to trigger the second gear shifting instruction. Then, in response to the second gear shifting instruction, it may display downshifting the gear of the virtual vehicle.

In some embodiments, the third side refers to the left side, and the fourth side refers to the right side. Alternatively, the third side refers to the right side, and the fourth side refers to the left side. Alternatively, the third side refers to the upper side, and the fourth side refers to the lower side. Alternatively, the third side refers to the lower side, and the fourth side refers to the upper side. For the tapping operation on the side frame of the terminal, the client will also detect the effectiveness. For the specific detection process of the tapping operation on the side frame of the terminal, reference may be made to the detection process of the tapping operation on the back surface of the terminal, which will not be repeated here. In the method provided in this embodiment, the gear shifting instruction is triggered by tapping the side frame of the terminal, thus providing a scheme for conveniently and accurately triggering the gear shifting instruction.

### When the Gear Shifting Instruction is Triggered in Other Ways

The terminal responds to a first double-finger sliding operation along a first direction in the user interface, and the client displays upshifting the gear of the virtual vehicle; and/or, the terminal responds to a second double-finger sliding operation along a second direction in the user interface, and the client displays downshifting the gear of the virtual vehicle. Two sliding trajectories of the first double-finger sliding operation are respectively located on two sides of the user interface, and two sliding trajectories of the second double-finger sliding operation are respectively located on two sides of the user interface.

In some embodiments, two sliding trajectories of the first double-finger sliding operation and the second double-finger sliding operation are respectively located on a left side and a right side of the user interface. The first direction is opposite to the second direction. For example, the first direction is upward and the second direction is downward. Since the user usually uses both hands to respectively perform operations on the left side and the right side of the user interface, when executing gear shifting through the above scheme, the user may use both thumbs to slide up at the same time, thus triggering upshifting the gear of the virtual vehicle by one gear; and/or, the user may use both thumbs to slide down at the same time, thus triggering downshifting the gear of the virtual vehicle by one gear. Since gear shifting is triggered through double-finger operations, while other operations in the game are usually single-finger operations, the probability of false determination of the client is low, thus achieving accurate control of the gear of the virtual vehicle.

In some embodiments, the client displays a gear shifting control in the user interface in at least one of the following cases: a distance between the virtual vehicle and an opponent virtual vehicle in the virtual environment being less than a first distance threshold; and a distance between the virtual vehicle and a bent road section in the virtual environment being less than a second distance threshold (in this case, the virtual vehicle is a virtual automobile). The opponent virtual vehicle is a virtual vehicle controlled by another user or the client/server. The first distance threshold and the second distance threshold are set by the client or the user. The gear shifting control is configured to trigger at least one of downshifting the gear of the virtual vehicle and upshifting the gear of the virtual vehicle. In some embodiments, the gear shifting control includes a first control and a second control, the first control is configured to trigger upshifting the gear of the virtual vehicle by one gear, and the second control is configured to trigger downshifting the gear of the virtual vehicle by one gear. The user may set the position of the gear shifting control in the user interface to facilitate the user operation.

The above scheme for triggering the gear shifting instruction through non-tapping operations in this embodiment of this application may operate simultaneously with the scheme for triggering the gear shifting instruction through tapping operations. In the method provided in this embodiment, the gear shifting instruction is triggered through double-finger sliding operations in different directions, thus providing a scheme for triggering the gear shifting instruction through operations different from conventional operations of controlling the virtual vehicle. Not only does it avoid conflicts with conventional operations, but it also achieves accurate control of gear shifting of the virtual vehicle. In the method provided in this embodiment, by displaying the gear shifting control in scenarios where manual control of the gear of the virtual vehicle may be required, the user can manually control the gear of the virtual vehicle through the gear shifting control in the scenarios, thus achieving accurate control of the virtual vehicle.

Through the method provided in this embodiment of this application, the user can easily and smoothly use the manual mode to operate the virtual automobile on the mobile device, and the gear shifting process can be implemented in a way that it conforms to the operation through the gear shifting paddles of the automobile in the real world, thus making the interaction more diversified. At the same time, the introduction of the manual mode design can make racing games more enjoyable in operation, thus improving the gaming experience. The user can achieve convenient and smooth shifting between low gears and high gears, thus improving the upper limit of operation and improving the gaming enjoyment. In addition, in the game using the method provided in this embodiment of this application, for the experience of controlling the virtual automobile to pass through a bend, since the user can control the gear of the virtual automobile, the uncertainty of the game can be increased, thus improving the gaming experience for advanced players.

To sum up, in the method provided in this embodiment, through the tapping operation on the terminal, shifting the gear of the virtual vehicle, that is, upshifting the gear of the virtual vehicle and/or downshifting the gear of the virtual vehicle, can be triggered. The tapping operation is different from a touch operation on a display screen of the terminal, and will not influence or be influenced by the touch operation of a user on the display screen, thus achieving high operation accuracy. Therefore, the user can accurately control the gear of the virtual vehicle through the tapping operation, thus achieving the accurate control of the virtual vehicle.

In the method provided in this embodiment, by triggering upshifting the gear of the virtual vehicle or downshifting the gear of the virtual vehicle through different tapping operations, accurate control of the gear of the virtual vehicle can be achieved. In the method provided in this embodiment, upshifting the gear of the virtual vehicle or downshifting the gear of the virtual vehicle is triggered through operations of tapping different positions on the back surface of the terminal. The user can selectively shifting the gear of the virtual vehicle by tapping different positions on the back surface of the terminal, thus achieving accurate control of the gear of the virtual vehicle. In the method provided in this embodiment, the gear shifting instruction triggered by the tapping operation is determined through the acceleration at the virtual sampling point, thus providing a scheme for accurately identifying the tapping operation to trigger the gear shifting instruction. In the method provided in this embodiment, whether the tapping operation is located on the first side or the second side is determined according to the identifiers of the virtual sampling points, thus providing a scheme for conveniently determining the position of the tapping operation. In the method provided in this embodiment, the gear shifting instruction is triggered only when the force and direction of the tapping operation meet the conditions, thus preventing the gear shifting instruction from being triggered falsely. In the method provided in this embodiment, the gear shifting instruction is triggered through multiple consecutive tapping operations, thus effectively avoiding false identification of the tapping operations. In the method provided in this embodiment, the gear shifting instruction is triggered by tapping the side frame of the terminal, thus providing a scheme for conveniently and accurately triggering the gear shifting instruction. In the method provided in this embodiment, the gear shifting instruction is triggered through double-finger sliding operations in different directions, thus providing a scheme for triggering the gear shifting instruction through operations different from conventional operations of controlling the virtual vehicle. Not only does it avoid conflicts with conventional operations, but it also achieves accurate control of gear shifting of the virtual vehicle. In the method provided in this embodiment, by displaying the gear shifting control in scenarios where manual control of the gear of the virtual vehicle may be required, the user can manually control the gear of the virtual vehicle through the gear shifting control in the scenarios, thus achieving accurate control of the virtual vehicle. In the method provided in this embodiment, by triggering switching to the manual mode through the consecutive tapping operations when the virtual vehicle is in automatic mode, the user can flexibly switch the gear shifting mode of the virtual vehicle according to needs, thus improving the user experience.

In this application, before collecting user related data (such as motion sensor data) and in the process of collecting the user related data, a prompt interface or a pop-up window may be displayed, or voice prompt information may be outputted. The prompt interface, the pop-up window, or the voice prompt information is configured for prompting the user that the user related data are collected currently, so that this application only starts the relevant operation of acquiring the user related data after obtaining the user's confirmation operation on the prompt interface or the pop-up window. Otherwise (that is, when the user's confirmation operation on the prompt interface or the pop-up window is not obtained), the relevant operation of acquiring the user related data will be ended, that is, the user related data will not be acquired. In other words, all user data collected in this application are collected with the user's consent and authorization, and the collection, use, and processing of the user related data are required to comply with relevant laws, regulations, and standards in the relevant countries and regions. The sequence of the operations of the method provided in this embodiment of this application may be adjusted appropriately, and the operations may also be added or removed accordingly according to the situation. Any method that can be easily thought of by those skilled in the art within the technical scope disclosed in this application is included in the scope of protection of this application, which will not be repeated here.

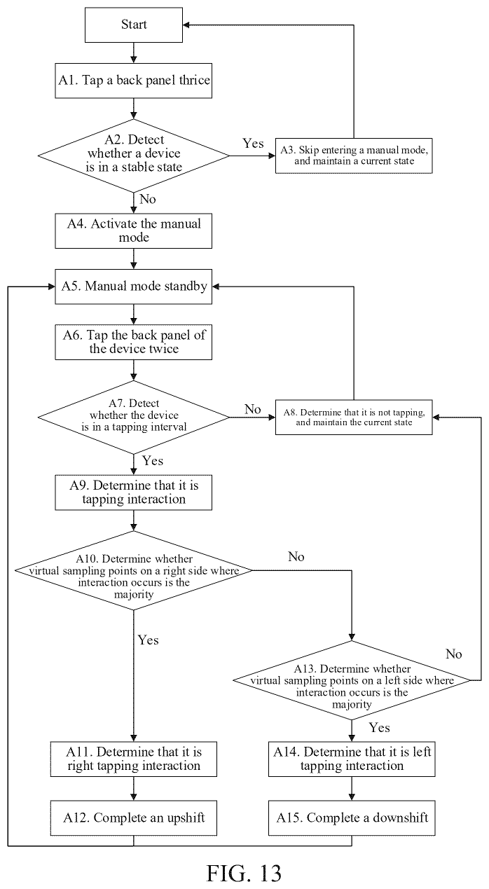

In a specific example, FIG. 13 is a schematic diagram of an operation process of shifting a gear according to an exemplary embodiment of this application. Referring to FIG. 13, in operation A1, a user taps a back panel of a device (terminal) thrice. In operation A2, a client detects whether the device is in a stable state, that is, whether tapping operations are effective. In operation A3, when the device is in the stable state, the client skips entering a manual mode. In operation A4, when the device is not in the stable state, the client activates the manual mode. In operation A5, the client maintains the manual mode. In operation A6, the user taps the back panel of the device twice. In operation A7, the client detects whether the acceleration of tapping satisfies a set interval. In operation A8, if it does not satisfy the interval, it is determined that the tapping operations are not effective. In operation A9, if it satisfies the interval, it is determined that the tapping operations are effective, and tapping interaction exists. In operation A10, the client determines whether virtual sampling points on a right side of virtual sampling points where interaction exists are the majority. In operation A11, if the virtual sampling points on the right side are the majority, the client determines that the tapping operations are tapping operations on the right side. In operation A12, the client controls a virtual automobile to complete an upshift. In operation A13, if the virtual sampling points on the right side are not the majority, the client determines whether virtual sampling points on a left side of the virtual sampling points where interaction exists are the majority. In operation A14, if the virtual sampling points on the left side are the majority, the client determines that the tapping operations are tapping operations on the left side. In operation A15, the client controls the virtual automobile to complete a downshift. The detection process of the tapping operations will be described as follows.

### 1. Distribution of Virtual Sampling Points

Virtual sampling points are not actual hardware, but rather a data analysis model for an acceleration sensor in the device. Virtual sampling points are uniformly distributed in a 3D plane where the device is located, forming a surface. In the stable state, the acceleration of each virtual sampling point is zero. If there is acceleration deviation at one or more virtual sampling points, the stable state of the terminal may be determined.

### 2. Tapping identification (Whether Tapping is Effective)

By using the motion sensor of the device combined with 3D spatial coordinates, the acceleration generated by tapping is processed to determine whether the tapping is effective. Firstly, the client processes the parameters of the motion sensor to obtain absolute values of the acceleration at the virtual sampling points. If it is determined that the absolute values indicate an unstable state, it may be considered that the device has indeed been subjected to force, and the specific determination of tapping may be performed. If the absolute values of the acceleration fall within the tapping interval a1≤|Z|≤b1 defined above, it may be determined that the device has tapping interaction (tapping operation).

### 3. Tapping Position (Left and Right) Identification

In combination with the virtual sampling points mentioned in the first point, several virtual sampling points may be numbered. In order to ensure the accuracy of identification, the number of the virtual sampling points cannot be too small. Referring to FIG. 12, assuming that there are 50 sampling points, when the device experiences tapping interaction, the sampling points with single digits of 1-5 of the serial numbers may be defined as right sampling points representing the right side of the device according to the positions in the space. Contrarily, the sampling points with single digits of 6-10 of the serial numbers are left sampling points.

In combination with FIG. 10, since the current mobile device may usually be regarded as an integral rigid body without significant deformation, the device usually undergoes spatial displacement as a whole, and the direction of displacement (tapping direction) may be determined by the positive and negative values of the acceleration in the space. When the device generates acceleration in the positive direction on the Z-axis at the left sampling points in spatial coordinates, it may be considered that the left side of the device is tapped, and it is determined that the tapping is left tapping. When the device generates acceleration in the negative direction on the Z-axis at the left sampling points in spatial coordinates, it may be considered that the right side of the device is tapped, and it is determined that the tapping is right tapping.

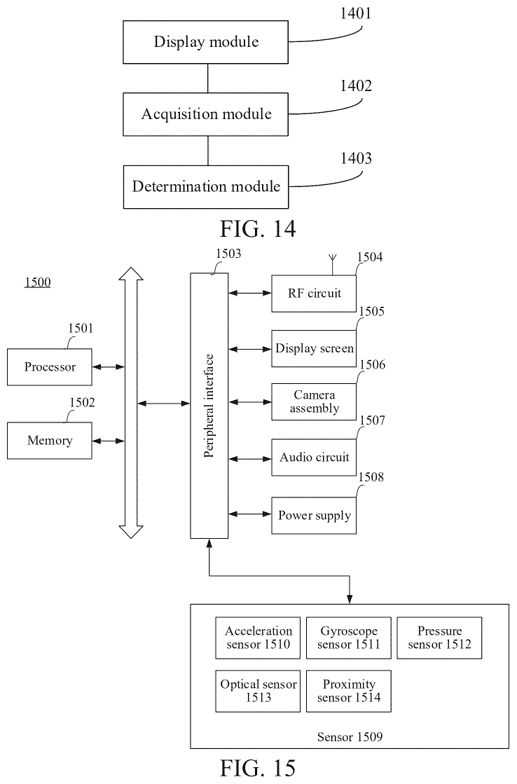

FIG. 14 is a schematic structural diagram of an apparatus for shifting a gear of a virtual vehicle according to an exemplary embodiment of this application. Referring to FIG. 14, the apparatus includes:
a display module 1401 configured to display, in a user interface, a virtual environment and the virtual vehicle in a travel state in the virtual environment, the virtual vehicle correspondingly having at least two gears; an acquisition module 1402 configured to acquire terminal motion data acquired by a motion sensor in a terminal in a process of displaying the user interface; and a determination module 1403 configured to determine a tapping operation on the terminal according to the terminal motion data, the tapping operation being an operation of tapping a surface of the terminal The display module 1401 is further configured to display, in response to a gear shifting instruction triggered by the tapping operation, at least one of upshifting the gear of the virtual vehicle and downshifting the gear of the virtual vehicle according to the gear shifting instruction.

In an exemplary design, the display module 1401 is configured to display upshifting the gear of the virtual vehicle in response to a first gear shifting instruction triggered by a first tapping operation; and/or, display downshifting the gear of the virtual vehicle in response to a second gear shifting instruction triggered by a second tapping operation.

In an exemplary design, the determination module 1403 is configured to determine to trigger the first gear shifting instruction in response to the first tapping operation with a tapping position located on a first side of a back surface of the terminal and a tapping direction facing towards the inside of the terminal The display module 1401 is configured to display upshifting the gear of the virtual vehicle in response to the first gear shifting instruction.

The determination module 1403 is further configured to determine to trigger the second gear shifting instruction in response to the second tapping operation with a tapping position located on a second side of the back surface of the terminal and a tapping direction facing towards the inside of the terminal. The display module 1401 is further configured to display downshifting the gear of the virtual vehicle in response to the second gear shifting instruction.

In an exemplary design, the determination module 1403 is configured to acquire acceleration generated by the terminal under the tapping operation through the motion sensor; determine an acceleration component of the acceleration at each virtual sampling point of a plurality of virtual sampling points, a direction of the acceleration component being a direction perpendicular to the back surface of the terminal, the plurality of virtual sampling points being distributed in a dot matrix form on a plane parallel to the back surface of the terminal; determine first virtual sampling points where the acceleration component satisfies a tapping condition from the virtual sampling points located on the first side; determine second virtual sampling points where the acceleration component satisfies the tapping condition from the virtual sampling points located on the second side, the tapping condition being configured for indicating that the virtual sampling point is subjected to tapping along a tapping direction, the tapping direction being a direction perpendicularly pointing to the inside of the terminal from the back surface of the terminal; determine that the tapping operation is the first tapping operation when a first number is greater than a second number; and determine that the tapping operation is the second tapping operation when the first number is less than the second number, the first number being a number of the first virtual sampling points, the second number being a number of the second virtual sampling points.

In an exemplary design, each virtual sampling point corresponds to an identifier, the identifiers corresponding to the virtual sampling points located on the first side have the same first feature, and the identifiers corresponding to the virtual sampling points located on the second side have the same second feature. The determination module 1403 is configured to determine target virtual sampling points where the acceleration component satisfies the tapping condition from the multiple virtual sampling points; determine that the target virtual sampling points are the first virtual sampling points when the identifiers corresponding to the target virtual sampling points have the first feature; and determine that the target virtual sampling points are the second virtual sampling points when the identifiers corresponding to the target virtual sampling points have the second feature.

In an exemplary design, the determination module 1403 is configured to determine that the virtual sampling point satisfies the tapping condition when an absolute value of the acceleration component at the virtual sampling point is greater than a first threshold and less than a second threshold, and the direction of the acceleration component at the virtual sampling point is the tapping direction.

In an exemplary design, the display module 1401 is configured to display upshifting the gear of the virtual vehicle by one gear in response to the first gear shifting instruction triggered once by consecutive m first tapping operations, m being a positive integer; and display downshifting the gear of the virtual vehicle by one gear in response to the second gear shifting instruction triggered once by consecutive n second tapping operations, n being a positive integer.

In an exemplary design, the determination module 1403 is configured to determine to trigger the first gear shifting instruction in response to the first tapping operation with a tapping position located on a side frame of a third side of the terminal and a tapping direction facing towards the inside of the terminal. The display module 1401 is configured to display upshifting the gear of the virtual vehicle in response to the first gear shifting instruction. The determination module 1403 is further configured to determine to trigger the second gear shifting instruction in response to the second tapping operation with a tapping position located on a side frame of a fourth side of the terminal and a tapping direction facing towards the inside of the terminal. The display module 1401 is further configured to display downshifting the gear of the virtual vehicle in response to the second gear shifting instruction.

In an exemplary design, the display module 1401 is configured to display upshifting the gear of the virtual vehicle in response to a first double-finger sliding operation along a first direction in the user interface, two sliding trajectories of the first double-finger sliding operation being respectively located on two sides of the user interface; and/or, display downshifting the gear of the virtual vehicle in response to a second double-finger sliding operation along a second direction in the user interface, two sliding trajectories of the second double-finger sliding operation being respectively located on two sides of the user interface.

In an exemplary design, the display module 1401 is configured to display a gear shifting control in the user interface in at least one of the following cases: a distance between the virtual vehicle and an opponent virtual vehicle in the virtual environment being less than a first distance threshold; and a distance between the virtual vehicle and a bent road section in the virtual environment being less than a second distance threshold. The gear shifting control is configured to trigger at least one of downshifting the gear of the virtual vehicle and upshifting the gear of the virtual vehicle.

In an exemplary design, the display module 1401 is configured to display, in the user interface, switching a gear shifting mode of the virtual vehicle to a manual mode in response to consecutive tapping operations when the gear shifting mode of the virtual vehicle is an automatic mode, the consecutive tapping operations being operations of tapping the terminal for consecutive x times, x being a positive integer; and display, in response to the gear shifting instruction triggered by the tapping operation, at least one of upshifting the gear of the virtual vehicle and downshifting the gear of the virtual vehicle according to the gear shifting instruction when the gear shifting mode of the virtual vehicle is the manual mode.

The apparatus for shifting the gear of the virtual vehicle provided in the above embodiment is exemplarily described by division of the functional modules. In actual application, the functions may be allocated to and completed by different functional modules according to requirements, that is, the internal structure of the device is divided into different functional modules, to implement all or some of the functions described above. In addition, the apparatus for shifting the gear of the virtual vehicle provided in the above embodiment and the method embodiment for shifting the gear of the virtual vehicle are based on the same concept. For details of the specific implementation process, reference may be made to the method embodiment, which will not be repeated here.

An embodiment of this application further provides a computer device. The computer device includes a processor and a memory. The memory has at least one program stored therein. The at least one program is loaded and executed by the processor to implement the method for shifting the gear of the virtual vehicle provided in each method embodiment described above. For example, FIG. 15 is a schematic structural diagram of a terminal according to an exemplary embodiment of this application. Generally, the terminal 1500 includes a processor 1501 and a memory 1502. The processor 1501 may include one or more processing cores, such as a 4-core processor or an 8-core processor. The processor 1501 may be implemented in at least one hardware form of a Digital Signal Processor (DSP), a Field-Programmable Gate Array (FPGA), and a Programmable Logic Array (PLA). The processor 1501 may also include a main processor and a coprocessor. The main processor is configured to process data in an active state, also referred to as a Central Processing Unit (CPU). The coprocessor is a low power consumption processor configured to process data in a standby state. In some embodiments, the processor 1501 may be integrated with a Graphics

Processing Unit (GPU). The GPU is configured to render and draw content that needs to be displayed on a display screen. In some embodiments, the processor 1501 may further include an Artificial Intelligence (AI) processor. The AI processor is configured to process computing operations related to machine learning. The memory 1502 may include one or more computer-readable storage media. The computer-readable storage medium may be non-transient. The memory 1502 may further include a high-speed random-access memory and a non-volatile memory, for example, one or more disk storage devices or flash storage devices. In some embodiments, the non-transitory computer-readable storage medium in the memory 1502 is configured to store at least one instruction. The at least one instruction is executed by the processor 1501 to implement the method for shifting the gear of the virtual vehicle provided in the method embodiment of this application.

In some embodiments, the terminal 1500 may further includes a peripheral device interface 1503 and at least one peripheral. The processor 1501, the memory 1502, and the peripheral device interface 1503 may be connected through a bus or a signal cable. Each peripheral may be connected to the peripheral device interface 1503 through a bus, a signal cable, or a circuit board. Specifically, the peripheral includes at least one of a Radio Frequency (RF) circuit 1504, a display screen 1505, a camera assembly 1506, an audio circuit 1507, and a power supply 1508. The peripheral device interface 1503 may be configured to connect the at least one peripheral related to Input/Output (I/O) to the processor 1501 and the memory 1502. In some embodiments, the processor 1501, the memory 1502, and the peripheral device interface 1503 are integrated on the same chip or circuit board. In some other embodiments, any one or two of the processor 1501, the memory 1502, and the peripheral device interface 1503 may be implemented on a single chip or circuit board, which is not limited in embodiments of this application. The RF circuit 1504 is configured to receive and transmit an RF signal, also referred to as an electromagnetic signal. The RF circuit 1504 communicates with a communication network and other communication devices through the electromagnetic signal. The RF circuit 1504 converts an electric signal into an electromagnetic signal for transmission, or converts a received electromagnetic signal into an electric signal. In some embodiments, the RF circuit 1504 includes an antenna system, an RF transceiver, one or more amplifiers, a tuner, an oscillator, a DSP, a codec chipset, a user identity module card, and the like. The RF circuit 1504 may communicate with another terminal through at least one wireless communications protocol. The wireless communications protocol includes, but is not limited to, a worldwide web, a metropolitan area network, an intranet, various generations of mobile communication networks (2G, 3G, 4G, and 5G), a wireless local area network, and/or a wireless fidelity (WiFi) network. In some embodiments, the RF 1504 may further include a circuit related to Near Field Communication (NFC), which is not limited in this application. The display screen 1505 is configured to display a user interface (UI). The UI may include a graph, text, an icon, a video, and any combination thereof. When the display screen 1505 is a touch display screen, the display screen 1505 further has a capability of acquiring a touch signal on or above a surface of the display screen 1505. The touch signal may be inputted to the processor 1501 as a control signal for processing. In this case, the display screen 1505 may be further configured to provide a virtual button and/or a virtual keyboard, also referred to as a soft button and/or a soft keyboard. In some embodiments, the number of the display screen 1505 may be one, which is arranged on a front panel of the terminal 1500. In some other embodiments, the number of the display screens 1505 may be at least two, which are respectively arranged on different surfaces of the terminal 1500 or are in a foldable design. In some other embodiments, the display screen 1505 may be a flexible display screen arranged on a curved or folded surface of the terminal 1500. Even, the display screen 1505 may be further set in a non-rectangular irregular pattern, namely, a special-shaped screen. The display screen 1505 may be fabricated by using a material such as a Liquid Crystal Display (LCD) or an Organic Light-Emitting Diode (OLED). The camera component 1506 is configured to capture images or videos. In some embodiments, the camera assembly 1506 includes a front camera and a rear camera. Generally, the front camera is arranged on the front panel of the terminal 1500, and the rear camera is arranged on a back surface of the terminal. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1506 may further include a flash. The flash may be a monochrome temperature flash, or may be a double color temperature flash. The double color temperature flash refers to a combination of a warm light flash and a cold light flash, and may be used for light compensation under different color temperatures. The audio circuit 1507 may include a microphone and a speaker. The microphone is configured to acquire sound waves of a user and an environment, and convert the sound waves into an electrical signal to input to the processor 1501 for processing, or input to the RF circuit 1504 for implementing voice communication. For the purpose of stereo acquisition or noise reduction, there may be multiple microphones, which are respectively arranged at different portions of the terminal 1500. The microphone may further be an array microphone or an omni-directional acquisition type microphone. The speaker is configured to convert an electric signal from the processor 1501 or the RF circuit 1504 into sound waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 1507 may further include an earphone jack. The power supply 1508 is configured to supply power to components in the terminal 1500. The power supply 1508 may be alternating current, direct current, a primary battery, or a rechargeable battery. When the power supply 1508 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 1500 further includes one or more sensors 1509. The one or more sensors 1509 include, but are not limited to, an acceleration sensor 1510, a gyroscope sensor 1511, a pressure sensor 1512, an optical sensor 1513, and a proximity sensor 1514. The acceleration sensor 1510 may detect a magnitude of acceleration on three coordinate axes of a coordinate system established with the terminal 1500. For example, the acceleration sensor 1510 may be configured to detect components of gravity acceleration on the three coordinate axes. The processor 1501 may control, according to a gravity acceleration signal acquired by the acceleration sensor 1510, the touch display screen 1505 to display the user interface in a landscape view or a portrait view. The acceleration sensor 1510 may be further configured to acquire motion data of a game or a user. The gyroscope sensor 1511 may detect a body direction and a rotation angle of the terminal 1500. The gyroscope sensor 1511 may cooperate with the acceleration sensor 1510 to acquire a 3D action by the user on the terminal 1500. The processor 1501 may implement the following functions according to the data acquired by the gyroscope sensor 1511: motion sensing (such as changing the UI according to a tilt operation of the user), image stabilization at shooting, game control, and inertial navigation. The pressure sensor 1512 may be arranged on a side frame of the terminal 1500 and/or a lower layer of the touch display screen 1505. When the pressure sensor 1512 is arranged on the side frame of the terminal 1500, a holding signal of the user on the terminal 1500 may be detected. The processor 1501 performs left and right hand recognition or a quick operation according to the holding signal acquired by the pressure sensor 1512. When the pressure sensor 1512 is arranged on the low layer of the touch display screen 1505, the processor 1501 controls, according to a pressure operation of the user on the display screen 1505, an operable control on the UI. The operable control includes at least one of a button control, a scroll-bar control, an icon control, and a menu control. The optical sensor 1513 is configured to acquire ambient light intensity. In an embodiment, the processor 1501 may control the display brightness of the touch display screen 1505 according to the ambient light intensity acquired by the optical sensor 1513. Specifically, when the ambient light intensity is relatively high, the display brightness of the touch display screen 1505 is increased. When the ambient light intensity is relatively low, the display brightness of the touch display screen 1505 is decreased. In another embodiment, the processor 1501 may further dynamically adjust a photographing parameter of the camera component 1506 according to the ambient light intensity acquired by the optical sensor 1513. The proximity sensor 1514, also referred to as a distance sensor, is generally disposed on the front panel of the terminal 1500. The proximity sensor 1514 is configured to acquire a distance between the user and the front surface of the terminal 1500. In an embodiment, when the proximity sensor 1514 detects that the distance between the user and the front surface of the computer device 1500 gradually decreases, the processor 1501 controls the touch display screen 1505 to switch from a screen-on state to a screen-off state. When the proximity sensor 1514 detects that the distance between the user and the front surface of the terminal 1500 gradually increases, the touch screen 1501 is controlled by the processor 1505 to switch from the screen-off state to the screen-on state.

A person skilled in the art may understand that the structure illustrated in FIG. 15 constitutes no limitation on the terminal 1500, and the terminal may include more or fewer components than those illustrated therein, or some components may be combined, or a different component arrangement may be adopted.

An embodiment of this application further provides a computer-readable storage medium. The computer-readable storage medium has at least one program stored therein. The at least one program, when loaded and executed by a processor of a computer device, implements the method for shifting the gear of the virtual vehicle provided in each method embodiment described above.

This application further provides a computer program product or a computer program. The computer program product or the computer program includes computer instructions. The computer instructions are stored in a computer-readable storage medium. A processor of a computer device reads the computer instructions from the computer-readable storage medium and executes the computer instructions, causing the computer device to perform the method for shifting the gear of the virtual vehicle provided in each method embodiment described above.

A person of ordinary skill in the art may understand that all or some of the operations of the foregoing embodiments may be implemented by hardware, or may be implemented by a program instructing relevant hardware. The program may be stored in a computer-readable storage medium. The readable storage medium may be a read only memory, a magnetic disk, an optical disc, or the like.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. What are described above are merely exemplary embodiments of this application, but are not intended to limit this application. Any modification, equivalent replacement, or improvement made within the spirit and principle of this application still fall within the scope of protection of this application.

What is claimed is:

1. A method for shifting a gear of a virtual vehicle in a virtual environment executed by a computer device, the method comprising:
displaying, in a user interface, the virtual vehicle in a travel state in the virtual environment, the virtual vehicle correspondingly having at least two gears;
acquiring terminal motion data from a motion sensor in the computer device;
determining a tapping operation on a surface of a display of the computer device according to the terminal motion data; and
in response to a gear shifting instruction triggered by the tapping operation, performing at least one of upshifting the gear of the virtual vehicle and downshifting the gear of the virtual vehicle according to the gear shifting instruction.

2. The method according to claim 1, wherein the performing at least one of upshifting the gear of the virtual vehicle and downshifting the gear of the virtual vehicle according to the gear shifting instruction comprises at least one of:
upshifting the gear of the virtual vehicle in response to a first gear shifting instruction triggered by a first tapping operation; and
downshifting the gear of the virtual vehicle in response to a second gear shifting instruction triggered by a second tapping operation,
wherein the first tapping operation is different from the second tapping operation in at least one of tapping position, tapping direction, and tapping force.

3. The method according to claim 2, wherein the upshifting the gear of the virtual vehicle in response to a first gear shifting instruction triggered by a first tapping operation comprises:
upshifting the gear of the virtual vehicle by one gear in response to the first gear shifting instruction triggered once by consecutive m first tapping operations, m being a positive integer;
the downshifting the gear of the virtual vehicle in response to a second gear shifting instruction triggered by a second tapping operation comprises:
downshifting the gear of the virtual vehicle by one gear in response to the second gear shifting instruction triggered once by consecutive n second tapping operations, n being a positive integer.

4. The method according to claim 2, wherein the upshifting the gear of the virtual vehicle in response to a first gear shifting instruction triggered by a first tapping operation comprises:
triggering the first gear shifting instruction in response to the first tapping operation with a tapping position located on a side frame of a third side of the terminal and a tapping direction facing towards the inside of the terminal; and upshifting the gear of the virtual vehicle in response to the first gear shifting instruction; and
the downshifting the gear of the virtual vehicle in response to a second gear shifting instruction triggered by a second tapping operation comprises:
triggering the second gear shifting instruction in response to the second tapping operation with a tapping position located on a side frame of a fourth side of the terminal and a tapping direction facing towards the inside of the terminal; and downshifting the gear of the virtual vehicle in response to the second gear shifting instruction.

5. The method according to claim 1, wherein the method further comprises at least one of:
upshifting the gear of the virtual vehicle in response to a first double-finger sliding operation along a first direction in the user interface, two sliding trajectories of the first double-finger sliding operation being respectively located on two sides of the user interface; and
downshifting the gear of the virtual vehicle in response to a second double-finger sliding operation along a second direction in the user interface, two sliding trajectories of the second double-finger sliding operation being respectively located on two sides of the user interface.

6. The method according to claim 1, wherein the method further comprises:
displaying a gear shifting control in the user interface when at least one of the following cases is met:
a distance between the virtual vehicle and an opponent virtual vehicle in the virtual environment being less than a first distance threshold; and
a distance between the virtual vehicle and a bent road section in the virtual environment being less than a second distance threshold,
wherein the gear shifting control is configured to trigger at least one of downshifting the gear of the virtual vehicle and upshifting the gear of the virtual vehicle.

7. The method according to claim 1, wherein the method further comprises:
switching a gear shifting mode of the virtual vehicle to a manual mode in response to consecutive tapping operations when the gear shifting mode of the virtual vehicle is an automatic mode; and
in response to the gear shifting instruction triggered by the tapping operation, performing at least one of upshifting the gear of the virtual vehicle and downshifting the gear of the virtual vehicle according to the gear shifting instruction when the gear shifting mode of the virtual vehicle is the manual mode.

8. A computer device, comprising a processor and a memory, the memory having at least one program stored therein, the at least one program, when loaded and executed by the processor, causing the computer device to implement a method for shifting a gear of a virtual vehicle in a virtual environment including:
displaying, in a user interface, the virtual vehicle in a travel state in the virtual environment, the virtual vehicle correspondingly having at least two gears;
acquiring terminal motion data from a motion sensor in the computer device;
determining a tapping operation on a surface of a display of the computer device according to the terminal motion data; and
in response to a gear shifting instruction triggered by the tapping operation, performing at least one of upshifting the gear of the virtual vehicle and downshifting the gear of the virtual vehicle according to the gear shifting instruction.

9. The computer device according to claim 8, wherein the performing at least one of upshifting the gear of the virtual vehicle and downshifting the gear of the virtual vehicle according to the gear shifting instruction comprises at least one of:
upshifting the gear of the virtual vehicle in response to a first gear shifting instruction triggered by a first tapping operation; and
downshifting the gear of the virtual vehicle in response to a second gear shifting instruction triggered by a second tapping operation,
wherein the first tapping operation is different from the second tapping operation in at least one of tapping position, tapping direction, and tapping force.

10. The computer device according to claim 9, wherein the upshifting the gear of the virtual vehicle in response to a first gear shifting instruction triggered by a first tapping operation comprises:
upshifting the gear of the virtual vehicle by one gear in response to the first gear shifting instruction triggered once by consecutive m first tapping operations, m being a positive integer;
the downshifting the gear of the virtual vehicle in response to a second gear shifting instruction triggered by a second tapping operation comprises:
downshifting the gear of the virtual vehicle by one gear in response to the second gear shifting instruction triggered once by consecutive n second tapping operations, n being a positive integer.

11. The computer device according to claim 9, wherein the upshifting the gear of the virtual vehicle in response to a first gear shifting instruction triggered by a first tapping operation comprises:
triggering the first gear shifting instruction in response to the first tapping operation with a tapping position located on a side frame of a third side of the terminal and a tapping direction facing towards the inside of the terminal; and upshifting the gear of the virtual vehicle in response to the first gear shifting instruction; and
the downshifting the gear of the virtual vehicle in response to a second gear shifting instruction triggered by a second tapping operation comprises:
triggering the second gear shifting instruction in response to the second tapping operation with a tapping position located on a side frame of a fourth side of the terminal and a tapping direction facing towards the inside of the terminal; and downshifting the gear of the virtual vehicle in response to the second gear shifting instruction.

12. The computer device according to claim 8, wherein the method further comprises at least one of:
upshifting the gear of the virtual vehicle in response to a first double-finger sliding operation along a first direction in the user interface, two sliding trajectories of the first double-finger sliding operation being respectively located on two sides of the user interface; and
downshifting the gear of the virtual vehicle in response to a second double-finger sliding operation along a second direction in the user interface, two sliding trajectories of the second double-finger sliding operation being respectively located on two sides of the user interface.

13. The computer device according to claim 8, wherein the method further comprises:
displaying a gear shifting control in the user interface when at least one of the following cases is met:
a distance between the virtual vehicle and an opponent virtual vehicle in the virtual environment being less than a first distance threshold; and
a distance between the virtual vehicle and a bent road section in the virtual environment being less than a second distance threshold,
wherein the gear shifting control is configured to trigger at least one of downshifting the gear of the virtual vehicle and upshifting the gear of the virtual vehicle.

14. The computer device according to claim 8, wherein the method further comprises:
switching a gear shifting mode of the virtual vehicle to a manual mode in response to consecutive tapping operations when the gear shifting mode of the virtual vehicle is an automatic mode; and
in response to the gear shifting instruction triggered by the tapping operation, performing at least one of upshifting the gear of the virtual vehicle and downshifting the gear of the virtual vehicle according to the gear shifting instruction when the gear shifting mode of the virtual vehicle is the manual mode.

15. A non-transitory computer-readable storage medium storing at least one program stored therein, the at least one program, when loaded and executed by a processor of a computer device, causing the computer device to implement a method for shifting a gear of a virtual vehicle in a virtual environment including:
displaying, in a user interface, the virtual vehicle in a travel state in the virtual environment, the virtual vehicle correspondingly having at least two gears;
acquiring terminal motion data from a motion sensor in the computer device;
determining a tapping operation on a surface of a display of the computer device according to the terminal motion data; and
in response to a gear shifting instruction triggered by the tapping operation, performing at least one of upshifting the gear of the virtual vehicle and downshifting the gear of the virtual vehicle according to the gear shifting instruction.

16. The non-transitory computer-readable storage medium according to claim 15, wherein the performing at least one of upshifting the gear of the virtual vehicle and downshifting the gear of the virtual vehicle according to the gear shifting instruction comprises at least one of:
upshifting the gear of the virtual vehicle in response to a first gear shifting instruction triggered by a first tapping operation; and
downshifting the gear of the virtual vehicle in response to a second gear shifting instruction triggered by a second tapping operation,
wherein the first tapping operation is different from the second tapping operation in at least one of tapping position, tapping direction, and tapping force.

17. The non-transitory computer-readable storage medium according to claim 16, wherein the upshifting the gear of the virtual vehicle in response to a first gear shifting instruction triggered by a first tapping operation comprises:
upshifting the gear of the virtual vehicle by one gear in response to the first gear shifting instruction triggered once by consecutive m first tapping operations, m being a positive integer;
the downshifting the gear of the virtual vehicle in response to a second gear shifting instruction triggered by a second tapping operation comprises:
downshifting the gear of the virtual vehicle by one gear in response to the second gear shifting instruction triggered once by consecutive n second tapping operations, n being a positive integer.

18. The non-transitory computer-readable storage medium according to claim 16, wherein the upshifting the gear of the virtual vehicle in response to a first gear shifting instruction triggered by a first tapping operation comprises:
triggering the first gear shifting instruction in response to the first tapping operation with a tapping position located on a side frame of a third side of the terminal and a tapping direction facing towards the inside of the terminal; and upshifting the gear of the virtual vehicle in response to the first gear shifting instruction; and
the downshifting the gear of the virtual vehicle in response to a second gear shifting instruction triggered by a second tapping operation comprises:
triggering the second gear shifting instruction in response to the second tapping operation with a tapping position located on a side frame of a fourth side of the terminal and a tapping direction facing towards the inside of the terminal; and downshifting the gear of the virtual vehicle in response to the second gear shifting instruction.

19. The non-transitory computer-readable storage medium according to claim 15, wherein the method further comprises at least one of:
upshifting the gear of the virtual vehicle in response to a first double-finger sliding operation along a first direction in the user interface, two sliding trajectories of the first double-finger sliding operation being respectively located on two sides of the user interface; and
downshifting the gear of the virtual vehicle in response to a second double-finger sliding operation along a second direction in the user interface, two sliding trajectories of the second double-finger sliding operation being respectively located on two sides of the user interface.

20. The non-transitory computer-readable storage medium according to claim 15, wherein the method further comprises:
displaying a gear shifting control in the user interface when at least one of the following cases is met:
a distance between the virtual vehicle and an opponent virtual vehicle in the virtual environment being less than a first distance threshold; and
a distance between the virtual vehicle and a bent road section in the virtual environment being less than a second distance threshold,
wherein the gear shifting control is configured to trigger at least one of downshifting the gear of the virtual vehicle and upshifting the gear of the virtual vehicle.
